(19) United States
(12) Patent Application Publication
(10) Pub. No.: US 2013/0275884 A1
(43) Pub. Date: Oct. 17, 2013

(54) MANAGING MODERATION OF USER-CONTRIBUTED EDITS

(71) Applicant: GOOGLE INC., Mountain View, CA (US)

(72) Inventors: Lalitesh Kumar Katragadda, Banglore (IN); Brian A. McClendon, Portola Valley, CA (US); Rachna Agarwal, Banglore (IN); Robin Anil, Banglore (IN)

(73) Assignee: Google Inc., Mountain View, CA (US)

(21) Appl. No.: 13/862,359

(22) Filed: Apr. 12, 2013

Related U.S. Application Data
(60) Provisional application No. 61/623,500, filed on Apr. 12, 2012.

(51) Int. Cl. H04L 29/06

(52) U.S. Cl. CPC H04L 65/403
USPC 715/753

(57) ABSTRACT

A geographic information system allows users to access a map database and to contribute map data to the database. Proposed edits to the map are queued for review by a reviewer users. Reviewing users can subscribe to review edits in regions and/or to types of map features. Reviewers can share their subscriptions with other reviewers. In the moderation queue, the proposed edits are ranked and those edits proposed by users who also review are optionally ranked higher and thus reviewed sooner than edits proposed by users who do not review or review less. The history of reviewers is analyzed to identify those with expertise in a particular region and/or type of map feature. One embodiment of the system includes a database containing geographic data, an inference module, a spam prevention module, a reviewing module and a publishing module.

### BACKGROUND OF THE INVENTION

1. Field of the Invention

The present invention is related to on-line map databases and, more particularly to managing user-contributed edits to map information.

2. Description of the Background Art

Conventionally, acquiring the data necessary to create a map requires vast amounts of time and resources. The data required to create a map (“map data”) includes geographic data, such as latitude, longitude, elevation, location of geographic features of interest (e.g., bodies of water, mountains, forests); political data, such as country, state, and city boundaries, locations of streets and roadways, points of interest (e.g., government buildings, universities, stadiums), address numbering on a street; and attributes of features, such as whether or not an area is public and the nature of the surface of a street. Acquiring this data traditionally requires sending expert observers to the location to be mapped. Since experts are used to acquire the map data, it is generally deemed reliable and of sufficient quality for the map maker's usage. Because of the expense of acquiring map data, the map and the data necessary to create it are frequently proprietary. This adds to the cost of providing maps to users whether it is in hard copy form or on through online media, such as the World Wide Web.

Additionally, because of the expense involved, map data is not verified frequently. Therefore, if there is an error in or a change to the existing map data, it can take a long time for a map to be corrected or to be changed to reflect an addition. Even maps available in map websites on the World Wide Web can take a year or more to reflect a correction or addition. This can lead to very frustrating experiences for users of these maps. A user may obtain driving directions from a map website, but get lost while following such directions because there was an error in the map data, such as a closed street, or a change in street name or the like.

### SUMMARY OF THE INVENTION

A method and system allows users of a website to access a map database and to contribute map data to the database. The system is adapted to receive from a user an edit to the map data, such as a correction to an existing feature in the map data, a deletion of an existing feature or an addition of a new feature in the map data. The system is further configured to allow reviewers to review proposed edits, subscribe to certain types of edits to review and share their subscriptions with other reviewers. The system is further configured to rank proposed edits in a moderation queue based in part on whether the user making the edit is also a reviewer and how many proposed edits that user has reviewed. The system is further configured to analyze the reviewing history of reviewers and identify reviewers with particular areas of expertise, either geographically, by category of map feature or both. The system is further configured to publish the edit, so that the map reflects the correction of the feature or addition of the feature for the next user who requests a map of the area in which the edit was made.

The system includes a server and a database containing geographic data. The server can comprise a plurality of modules, including an inference module, a spam prevention module, a reviewing module and a publishing module. The inference module analyzes edits received from users and suggests changes to the edit. The spam prevention module determines the reliability of an edit. The reviewing module obtains feedback from reviewers about the edit. Alternatively, a single module determines the reliability of an edit and obtains feedback from reviewers. The publishing module pushes the edit to the map.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF DRAWINGS

FIG. 1 is a diagram of system architecture according to one embodiment.

FIG. 2 is a data flow chart showing a method of editing map data according to one embodiment.

FIGS. 3A-3D are screenshots showing an interface for modifying an existing map feature according to one embodiment.

FIG. 4 is a flow chart illustrating life cycles of edits according to one embodiment.

FIG. 5 is a data flow chart illustrating a method of correcting an edit proposed by a user according to one embodiment.

FIGS. 6A-56B are screenshots illustrating how a proposed edit may be visually distinct from other map features according to one embodiment.

FIGS. 7A-7B are screenshots illustrating the addition of a road to a map according to one embodiment.

FIGS. 8A-8C are screenshots illustrating the addition of a business to a map according to one embodiment.

FIGS. 9A-9C are screenshots illustrating the system rejecting edits to the map that violate the rules of attributes of map features according to one embodiment.

FIG. 10 is a data flow chart illustrating a method of reviewing edits according to one embodiment.

FIG. 11A-11B are screenshots illustrating a user subscribing to review edits according to the user's interests according to one embodiment.

FIGS. 12A-12B are screenshots illustrating the display of edits to be reviewed displayed to the user after the user has logged in according to one embodiment.

FIGS. 13A-13B are screenshots of the dialog box provided to the reviewer via which the reviewer provides feedback about the proposed edit according to one embodiment.

FIG. 14 is a data flow chart illustrating a method of publishing edits according to one embodiment.

FIG. 15 is a screen shot illustrating a user's subscription to proposed edits to review.

### DETAILED DESCRIPTION OF THE DRAWINGS

### System Overview

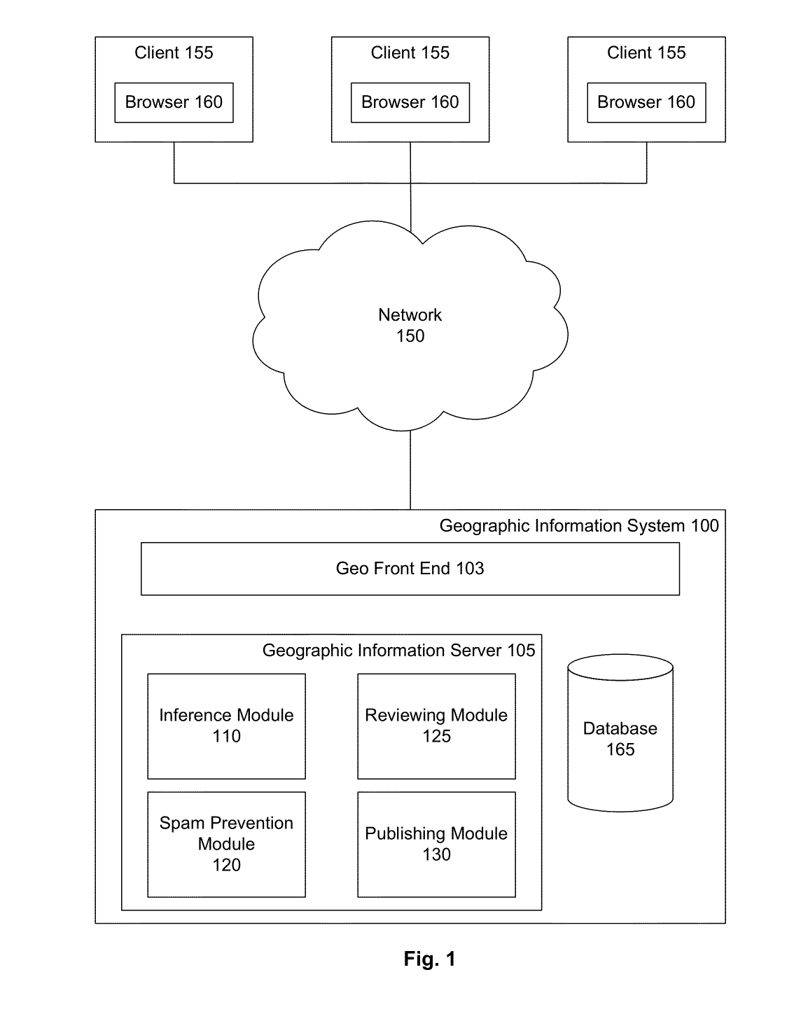

FIG. 1 is a diagram of system architecture according to one embodiment. The geographic information system (“GI System”) 100 includes a geo front end 103, a geographic information server (“GI Server”) 105 and database 165. A client 155 communicates with the GI server 105 via the network 150 and the GI server 105 communicates with the database 165 via the network 150. For simplicity, only three clients 155 are shown; in practice there will be numerous clients 155 communicating with GI server 105. Similarly, only a single GI server 105 is shown; in practice there will be many GI servers 105 in operation. The client 155 can be any type of computing device that is adapted to access the GI server 105 over the network 150. A browser 160 at the client 155 is a user interface used by the user to enter an addition or correction to map data.

The network 150 through which the client 155 and GI system 100 communicate can be any type of network, wired or wireless, known in the art. Examples include the Internet, a Local Area Network (LAN), an 802.11 network, an 802.16 network, a cellular network, or the like.

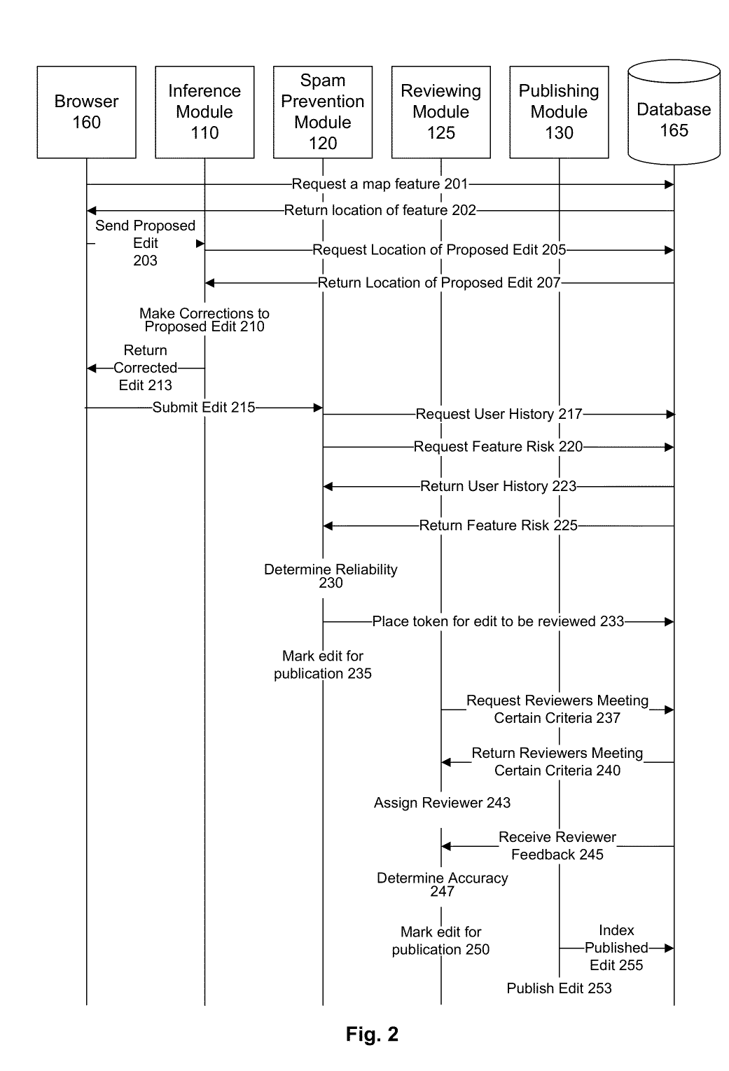

The GI server 105 comprises inference module 110, spam prevention module 120, reviewing module 125, and publishing module 130. The operation of these modules is discussed with respect to FIG. 2.

The database 165 stores all data related to the system. The data may be stored using any type of data storage system. Data includes map data, information about the users of the system, rules for making changes to the map data, edits and indices of this data.

In situations in which the system collects personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Map data is all data useful to create a map. Map data includes geographic data, such as latitude, longitude, elevation, political data, such as country, state, and city boundaries, address numbering on streets, features, events at features and attributes of features.

A feature is anything that might appear on a map that would be useful or of interest to those using a map. Examples of features include bodies of water, mountains, forests, cities, addresses, streets, and government buildings. Attributes are characteristics and properties of the feature that would be useful in describing the feature or of interest to those using a map. The attributes of a feature include inherent characteristics and properties but the attributes are not required to be inherent characteristics and properties. Examples of attributes include a phone number or operating hours for a business, the speed limit of a road, a menu for a restaurant, a train schedule for a train station, a bus schedule for a bus stop, weather conditions for a location, and so forth. The type of feature is also an attribute. The feature type is a class to which the feature belongs such as schools, restaurants, businesses, government buildings, etc.

Attributes of a feature can have dependencies on each other. These dependencies can reflect a semantic or real-world relation between the attributes, as would be understood by map users. For example, feature can have a zip code and a city attribute. The zip code attribute is semantically dependent on the city attribute, in that a change in the city attribute in most cases necessitates a change in the zip code attribute, but not necessarily vice versa (as most cities encompass multiple zip codes). Other attributes of a feature are not semantically dependent. For example, there is no semantic dependency between a telephone number of a business (a type of feature) and its operating hours. Some attributes are semantically dependent upon the type of feature, as not all features have the same attributes. For example, a road feature does not have a telephone number attribute. It can be appreciated that all attributes of a feature are semantically dependent upon the existence of a record for the feature. Dependencies between features and attributes and among attributes may be programmed by a system administrator.

An event at a feature is something that occurs at some point in time at a feature. Events can be individual events or repeating event. Examples of events include sales at stores that are features on the map, a farmer's market at a location on the map and festivals at parks on the map. Additionally, events include temporary changes in attributes of features. For example, if a road is under construction, it may be closed or only open to traffic in one direction for a given period of time. The closure of the road would constitute an event. Similarly, an event can be an accident on a road, a change in weather at a location (e.g., a thunderstorm or hail), or some significant hazard (e.g., a landslide, a fire, or a flood).

For editing purposes, features can be divided into a plurality of different categories, such as: features that are indicated by a point on a map, features that are indicated by a line on a map and features that are indicated by an area on map. Example map features that are indicated by points include addresses, street intersections, landmarks, natural features, buildings such as public transportation stations, schools, hospitals, fuel stations, offices, restaurants, and houses of worship. Example map features that are indicated by lines include roads and rivers. Example features that are indicated by an area on a map include neighborhoods and parks. Some map features can be indicated both by a point and/or an area on the map. An address is itself a point on a map but the address usually identifies a piece of land. The address could be a point on a map and the piece of land that has that address could be shown as an area on the map.

As the needs of users evolve, additional map features can be added. Map features and events can be searched for by a user and may be edited. An edit can include data specifying the feature before and after being edited as well as the source of the edit, when it was made, the reviewers of the edit and the rating of the edit.

The inference module 110 uses rules for map data to determine what is an acceptable edit, how to modify edits, and when an edit necessitates an additional edit. The rules can include the following: a) reverse geocoding to auto-fill addresses for features without addresses or for newly entered features; b) a metadata marker associated with each editable attribute of the feature which stores whether the attribute is user edited or auto-generated; c) rules to have auto-generated content change based on new rules or changes to underlying data; d) logic to inherit attributes from nearby components; e) re-propagation that forces attributes of existing features to change because of a change made in proximity to that feature; f) rules that tie some attributes to other attributes; g) rules that are specific to certain countries or regions. Examples of rules include civil engineering standards for road construction and political geographical constraints. An example of a road construction standard is the maximum angle for a curve in a road. Examples of political geographical constraints are the facts that there are exactly fifty states in the United States, the boundaries of the states and the state names.

In an example of inheriting an attribute from a nearby component, a newly added road section extending from an existing road will inherit physical attributes including, for example, road surface, number of lanes, and the speed limit. An example of re-propagation rules includes modifying the speed limit on a whole road if a user has modified the speed limit on a portion of the road. An example of an attribute that is tied to other attributes can include speed limit. This attribute can be related to the type of surface of the road and the local laws.

Attributes are valuable not only to infer attributes of added features but also to enhance the searchability of the map. The more attributes a feature has, the more ways it can be found by other users. For example, if the operating times for stores are given, the user can not only search for stores that sell a particular product of interest to the user, but also for stores that will be open at the time that the user will be shopping. Additionally, attributes provide more data with which search results can be customized for a particular user, for example by filtering or sorting by various details of the attribute information.

### Process Overview

FIG. 2 is a sequence diagram showing a method of editing map data according to one embodiment. The functions of the various modules may be combined or divided differently than described in reference to this embodiment.

Using the browser 160 at a client 155, a user requests 201 a map feature; this request is transmitted to the database 165 via the geo front end 103 and the GI server 105. The location of the requested map feature is returned 202 to the browser 160 by the database 165 by providing a map page encoded with the feature information, which the browser 160 can then display on a display device. If the user would like to make a change or addition to the returned map, the user makes an edit and then sends 203 the proposed edit, via the browser 160, to the inference module 110.

An edit includes the addition of a feature not previously on the map, a change to an existing feature on the map or a deletion of an existing feature on the map. A change to an existing feature includes a change in its location, its name or another attribute of the feature. Adding, changing or deleting an event at a feature is also a change to a feature.

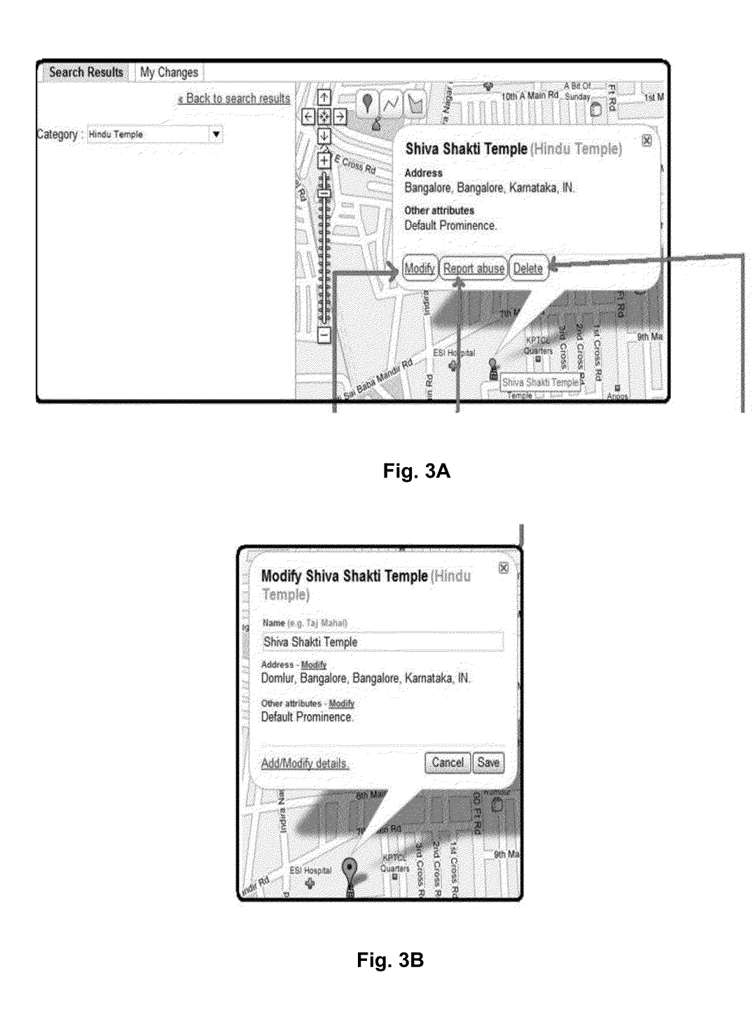

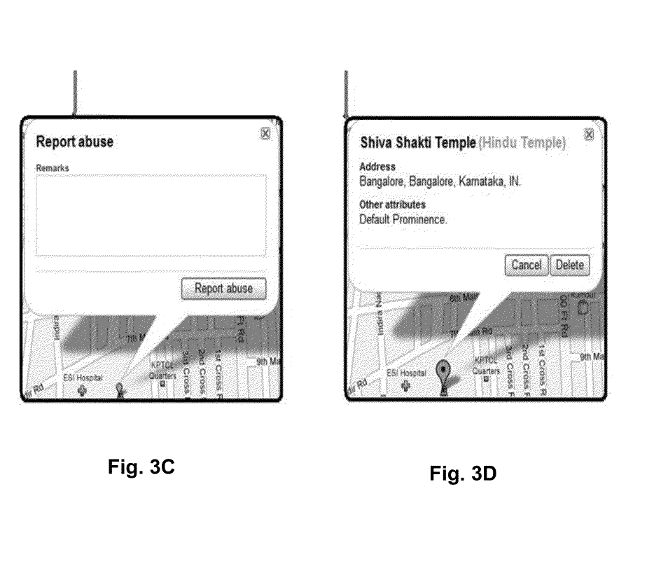

FIG. 3A illustrates a dialog box that can be displayed to a user when a map feature (e.g., “Shiva Shakti Temple”) is selected. As shown, the user has the option to “Modify” the attributes of the feature, “Delete” the feature, or “Report Abuse.”

FIG. 3B illustrates a dialog box associated with the “Modify” option, in which a user can change the name of a map feature or the details of the map feature.

FIG. 3C illustrates a dialog box associated with the “Report Abuse” option, in which a user can detail what the user perceives to be the abuse of that map feature, such as an error associated with the map feature that the user believes to be the result of a mischievous edit.

FIG. 3D illustrates a dialog box associated with the “Delete” option, in which a user can delete a map feature.

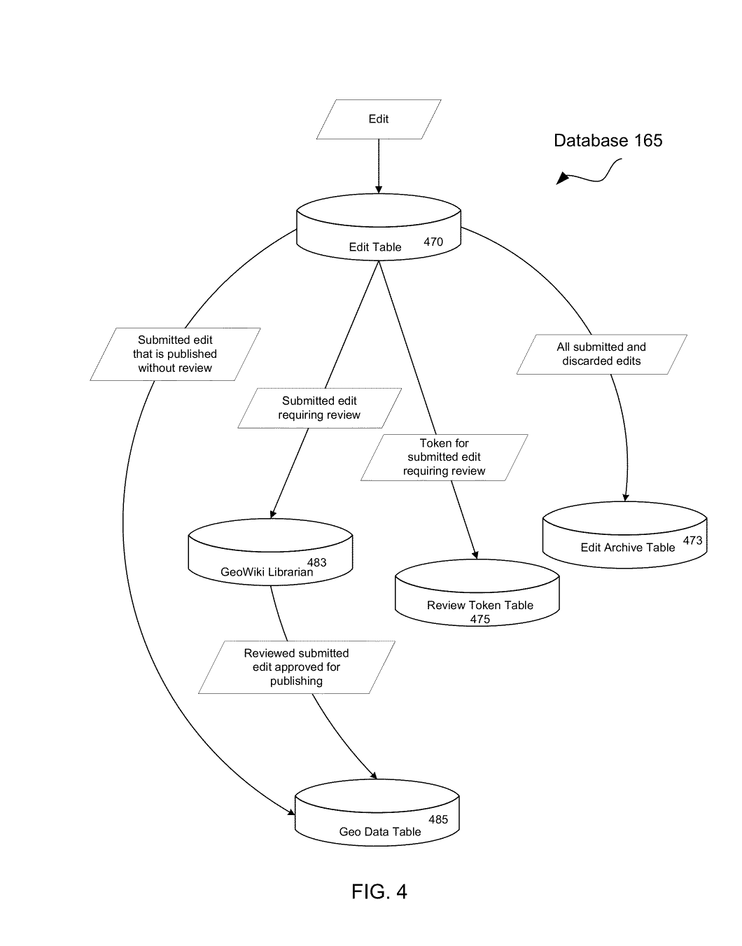

The lifecycle of an edit is illustrated in FIG. 4. While a user is making a proposed edit and prior to deciding whether or not to submit the proposed edit, the edit is stored in an edit table 470 in the database 165.

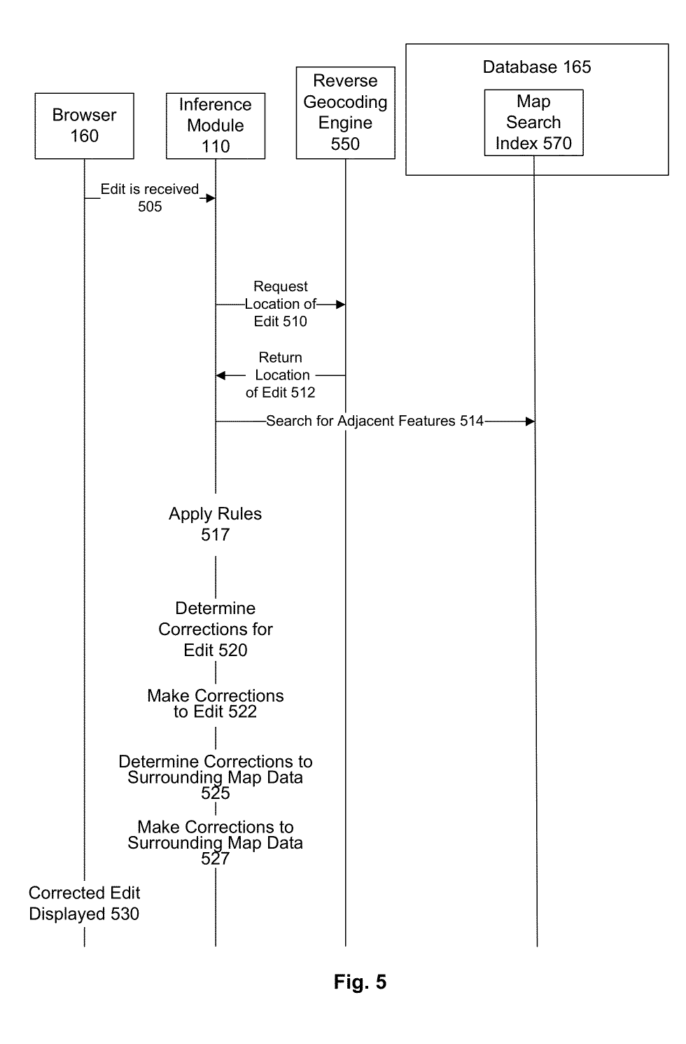

Upon receiving the proposed edit from the user, the inference module 110 requests 205 the location of the proposed edit from the reverse geocoding engine housed in the database 165. The reverse geocoding engine returns 207 the location of the proposed edit to the inference module 110. The operation of the reverse geocoding engine is discussed in greater detail with respect to FIG. 5. Using the location of the proposed edit the inference module 110 analyzes the proposed edit and determines corrections to the edit, if any. A correction is made if the proposed edit violates one or more of the rules for edits used by the inference module 110. As noted above, these rules can include, for example, road definition rules for road type, municipal boundaries and political information about countries. The inference module 110 makes 210 corrections to the proposed edit and returns 213 the corrected proposed edit to the user at the browser 160. The operation of the inference module 110 is discussed in greater detail with respect to FIG. 5.

In one embodiment, the user chooses whether or not to submit 215 the proposed edit for publication after the proposed edit has been returned by the inference module 110 (either modified or unmodified). If the proposed edit is not submitted by the user, it is discarded. All proposed edits, whether submitted or discarded, are stored in an edit archive table 473 in the database 165. The spam prevention module (SP Module) 120 uses a spam prevention model to determine 230 the reliability of the proposed edit. Proposed edits determined 230 to be reliable are marked 235 for publication and published 253 by the publishing module 130. Publishing 253 proposed edits promptly (e.g., substantially immediately after they are determined to be reliable) is desirable because additions and corrections to maps are available to other users of the maps without delay. In one embodiment, the spam prevention model is configured such that more than ninety percent of proposed edits are determined 230 to be reliable and published 253 without delay.

In order to determine 230 the reliability of the proposed edit, the SP module 120 requests 217 user history as well as requests 220 the feature risk signals for the feature being edited from the database 165. The database 165 returns 223 user history and returns 225 feature risk signals.

That data is entered into the spam prevention model at the SP module 120 and the reliability of the edit is determined 230. Edits determined to not be reliable are set for further review by moderator, administrator, or other authorized user. The SP module 120 places 233 a token associated with the proposed edit in a review token table 475 for proposed edits determined not to be reliable. The spam prevention model at the SP module 120 is discussed later in greater detail. The review token table 475 is in the database 165 and in addition to tokens for proposed edits requiring review, it stores whether or not the edit has been reviewed. Tokens signal to the reviewing module 125 that a proposed edit requires review. Data in a token includes information about the proposed edit including the map feature being edited and its attributes, the user who proposed the edit, the reviewer or reviewers that have been requested to review the proposed edit, the number of reviews required and how many reviews have already been completed. The advantages of this system can include one or more of: a) maintaining one global priority queue, b) assigning tokens to reviewers in geographic areas of their expertise, c) handling a large number of simultaneous reviews, d) quickly reassign a token to a new reviewer if the original reviewer did not review, e) allowing simultaneous review of a proposed edit by multiple reviewers, and f) detecting reviewers approving proposed edits in error.

Proposed edits requiring review are stored in a geowiki librarian 483 in the database 165. The reviewing module 125 applies tags to the proposed edits based on a variety of rules programmed into the reviewing module 125. Rules applying a tag based on the edit content, type of edit, source of the proposed edit, region in which the edited feature is located, user proposing the edit. The proposed edits are placed into a queue for reviewing and the queue is ranked based on a number of criteria. The ranking of the proposed edits is discussed in greater detail in the description of the operation of the reviewing module 125.

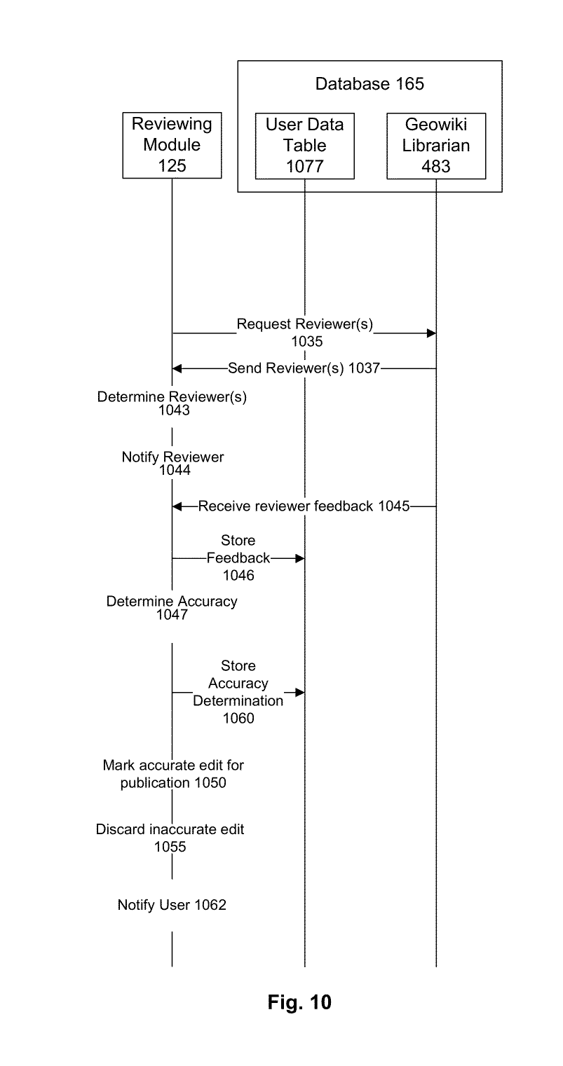

The reviewing module 125 requests 237 from the database 165 a list of reviewers meeting certain criteria. Reviewers can be fellow users or moderators. The database 165 returns 240 the list of reviewers meeting the criteria. In one embodiment, the criteria include information about geographic regions and/or types of map features that the reviewer has requested to review or that the reviewer has experience reviewing. The reviewing module 125 assigns 243 one or more reviewers to review each proposed edit. Each reviewer provides feedback on their assigned edits. The feedback from a reviewer is stored in association with the proposed edit in the geowiki librarian 483. Additionally, the feedback is indexed to the reviewer and the user who proposed the edit. The reviewing module 125 receives 245 reviewer feedback. Using the reviewer feedback, the reviewing module 125 determines 247 the accuracy of the proposed edit. The reviewing module 125 is discussed in greater detail with respect to FIG. 10.

In one embodiment proposed edits that are queued for review are indexed and therefore searchable and viewable by other users. Alternatively, the proposed edits that are queued for review are visible to other users but not indexed and therefore not searchable. The existing map data is displayed on geo tiles. A geo tile is an image of an area of the map that is stored and served when a user requests that area of the map. When an edit is proposed, one or more temporary geo tiles that display the edited feature are rendered substantially immediately. The temporary geo tiles are stored in the geowiki librarian 483. In an embodiment where the proposed edit is visible to other users, when the geo tile for an area requested by a user is served, any temporary geo tiles that overlap that tile are also served. In an embodiment where proposed edits are not visible to other users, the edited feature becomes visible to other users only after the edit has been determined to be reliable and/or accurate and published by the publishing module 130.

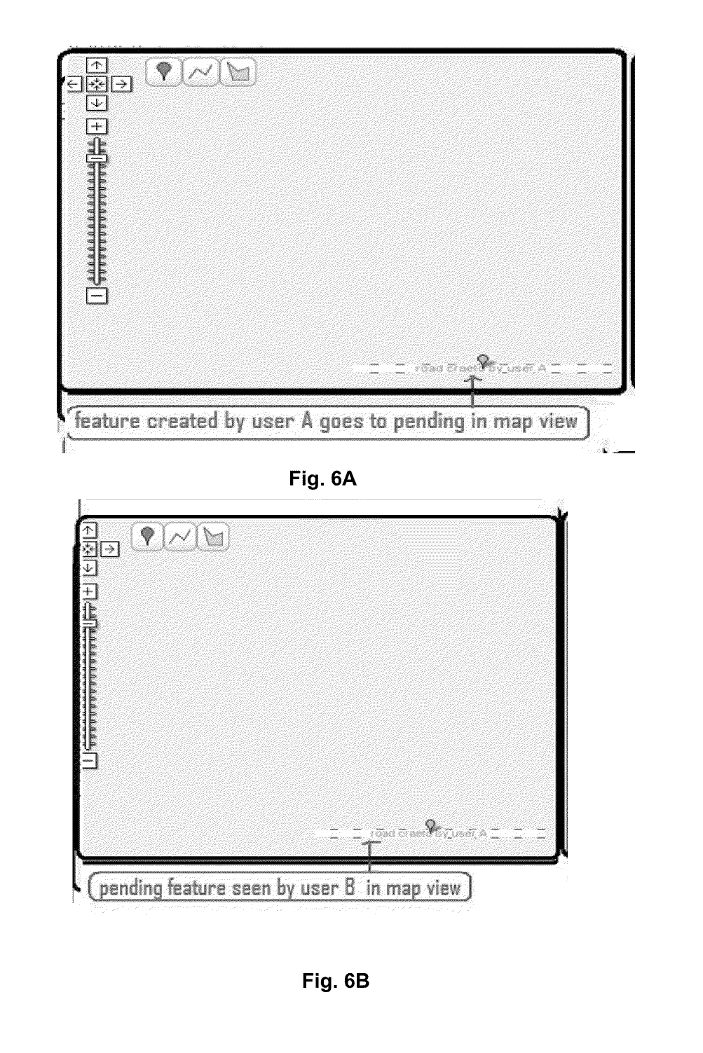

In an embodiment where proposed edits are visible to other users, the proposed edits are visually distinguishable from the rest of the map data as illustrated in FIGS. 6A-6B. Visual distinction includes making the proposed edits shades of grey when other map data is in full color or making the proposed edits translucent. In FIG. 6A, the proposed edit is visible but visually distinct in the map as viewed by the user who made the edit. FIG. 6B illustrates that the proposed edit is similarly visible, but visually distinct in the map as viewed by another user. Alternatively, proposed edits are visible to other users but not visually distinguishable from other map data.

Published edits are stored in a geo data table 485. The geo data table 485 is in the database 165 and stores all map data and geo tiles.

### Data Storage for Rapid Access and Incremental Real Time Updates

In one embodiment, the efficient operation of all of the different modules of the GI system 100 is facilitated by having all of the data in the database 165 organized in one or more tables in such a way that it may be accessed very quickly. The storage arrangement is organized so that features can be retrieved either by the feature's featureID, by region or by region and layer together. A layer is a grouping of similar features or related features. Certain features may appear in multiple layers. Examples include layers grouping all roads, all features related to real estate, or all parks in a map. A user can request to see a region with only the roads and the parks showing. Layers may be determined manually as well as automatically. Examples of layers determined automatically include a layer containing all proposed edits or a layer containing all features with a given attribute. When layers are determined automatically all known techniques can be used to expand the features included by using synonyms and hierarchies of the attributes as well as query expansion.

In one embodiment, the database is structured using a BigTable database model, as provided by Google Inc. and described more fully in “Bigtable: A Distributed Storage System for Structured Data” by Fay Chang, Jeffrey Dean, Sanjay Ghemawat, Wilson C. Hsieh, Deborah A. Wallach, Mike Burrows, Tushar Chandra, Andrew Fikes and Robert E. Gruber published in Proceedings of the 7^{th} USENIX Symposium on Operating Systems, pp 205-218, 2006. To create a table, the geographic area being mapped (e.g., the world or any portion thereof) is divided into quadrants. Each quadrant is subdivided again into quadrants resulting in quadrants that are different sizes. For example one quadrant may cover an area that is 8 km×8 km. That quadrant is subdivided into four quadrants that are 4 km×4 km. Quadrants of different sizes represent different zoom levels at which to view the map.

One zoom level is chosen to organize the features in the table. Each quadrant at that zoom level is represented by a row in the table, and every feature that is at least partially contained in the quadrant is a column stored in that row in the table. The zoom level chosen to organize the features is selected so as to limit the number of features per row, and the number of rows overall. In one embodiment, the size of a quadrant is selected so that there approximately 1,000 features per row and approximately 10,000,000 rows in the table.

A feature is uniquely identified by a featureID. A featureID comprises a cellID, and a fingerprint unique to the feature. The cellID for a feature is a location which can be the feature's location encoded down to a precise point. In one embodiment, the cellID is a 64-bit number, based upon a Hilbert curve. The fingerprint for a feature can be generated from a combination of attributes of the feature at the time the feature was created using any method known in the art. Alternatively, the fingerprint can be a random number. Multiple features can have the same cellID but will each have a unique fingerprint, and hence unique featureID. When the featureID is the geometric center or close to the geometric center of the feature, it can be faster to retrieve all features near each other because geocoding information is already inherent in the featureID.

For each layer in which a feature is visible, the layerID is stored with the featureID in the row for that map quadrant. The rows are identified by rowID's. All of the columns corresponding to a layerID for a feature are together a column family allowing compression of the data in a column family for increased efficiency. Each column identifies not only the feature but also a layerID in which it is visible for that quadrant of the map. Each column is a string representation of the featureID and the layerID in which that feature is visible. The feature contains the list of all layers in which it is visible. This allows the entire table to be reconstructed from the features alone. The feature is represented in the table in one column of the row as rowID:featureID. The featureID can be cellID:fingerprint or just fingerprint. Layers are represented in another column as rowID:featureID:layerID where the layerID goes to null. The presence of the column indicates that the feature is visible in that layer.

In some cases, an edit to a feature may result in the feature moving geographically. This could result in the feature being stored in a different row in the table and removed from the previous row. To facilitate retrieval of features that have moved in an embodiment where the cellID is the geometric center of the feature, a secondary index or table is constructed mapping the fingerprint of the feature to the current cellID. The cellID component of the featureID does not change even when the feature moves.

A wrapper class is used to set all data into the table. Accessors include retrieving all features visible in a given layer in a given region, retrieving all features in a given region regardless of resolution, and retrieving features within a predetermined distance from a given point for a given resolution.

### Writing to the Table

Updates to the table can be performed atomically. A locking mechanism is used to lock the featureID or row during writing to ensure that no other writes occur and all features are either written or not. The locking mechanism works by enforcement of locking protocols in the wrapper class. Locking a row locks all features in the row. A whole row cannot be locked however until individual features in the row are all unlocked. Rock lows and feature locks can include timeouts as well, to avoid system stalls.

In a BigTable embodiment, a single featureID can be locked or an entire row may be locked. Locking a single featureID is useful for time-critical tasks (e.g., online tasks) and acquiring a lock for a featureID is accomplished as follows:
Incrementing the lock counter for that featureID.
Check if the lock counter is 1. Check if the row counter is 0.
If lock counter >1 or row is locked, decrement counter by 1, return failure along with when the lock is likely to be available.
If lock counter is 1 and row counter is 0, update timestamp for that featureID to when the lock will be stale, return success.

When writing to the table offline, a lock is acquired for the entire row:
Incrementing the lock counter for that row.
Check if the lock counter for all featureIDs is 0 (or stale) and if row counter is 1.
If row counter is >1, decrement counter by 1, return failure.
If row counter is 1, set timestamp to when the lock will be stale. If some featureIDs are locked, wait until the latest stale time stamp and then return success.

A lock is released by decrementing the counter and setting timestamp to the current time. Other locking mechanisms known in the art may also be used. Various technologies for transactions processed with atomicity, consistency, isolation, and durability (ACID) embedded in table handlers could be applied.

Retrieval of Data from the Table

To facilitate retrieval of data, appropriate indices by cellID values, featureID values and fingerprint values are maintained. Any index known in the art may be used. An example is a hash table.

Given a featureID for a feature, the feature is retrieved by concurrent lookup of the current cellID using its fingerprint and attempt to lookup the feature using the cellID in the featureID as a hint. If the feature has not moved outside of its original cell, the cellID retrieved by the fingerprint will be the cellID in the featureID and the feature is retrieved. If the feature is not retrieved and the retrieved cellID is different, the feature is retrieved using the retrieved cellID.

Given a region, the features in the region are retrieved by determining all the quadrants that overlap with the specified region and retrieving all the features in these quadrants. A region is defined as one or more polygons. The region need not be a solid. A part in the center of the region may be excluded with the use of a negative polygon representing the area of the region to be excluded.

Given a region and specific layers within the region, the features in the region and the specified layers are retrieved by determining all the cells that overlap with the specified region, and retrieving the featureIDs in the given layers. If a user has specified that they do not wish to see features which appear in both a layer the user has requested and also a layer the user has not requested, further filtering is performed. This is accomplished by filtering featureID's based on layerID's, excluding the featureID's associated with layerID's that the user does not wish to see. This may be accomplished by any filtering method known in the art. The features corresponding to the fetched and filtered featureIDs are retrieved.

Alternatively all features are retrieved and filtering to exclude features that appear in both wanted and unwanted layers can be performed after the retrieval of all features. In yet another alternative embodiment, an index of the layer-to-feature mapping is maintained, and the server first determines which are visible in each specified layer from the index, and then retrieves the features.

Information in the database can be stored more than once. In one embodiment, each map feature is stored twice: first, the data is organized by feature type, and the second time it is organized by geographic location. When organized by geographic location, a single row in a data table will contain only the features in a given area. This allows the data to be located more quickly when it needs to be accessed.

Alternatively, the map features can be indexed in two different indices, one by feature type and one by geographic location. Additionally, each map feature is stored together with the history of all of its metadata allowing that to be located quickly as well.

### Operation of the Inference Module

FIG. 5 is a sequence diagram illustrating a method of correcting an edit proposed by a user according to one embodiment. When a user enters an edit via the browser 160 at the client 155, it is received 505 by the inference module via the geo front end 103. In order to assess whether or not the edit requires correction, the inference module 110 requests 510 the geographic location of the edit, and applies 517 rules based on the type of feature and the location of the edit.

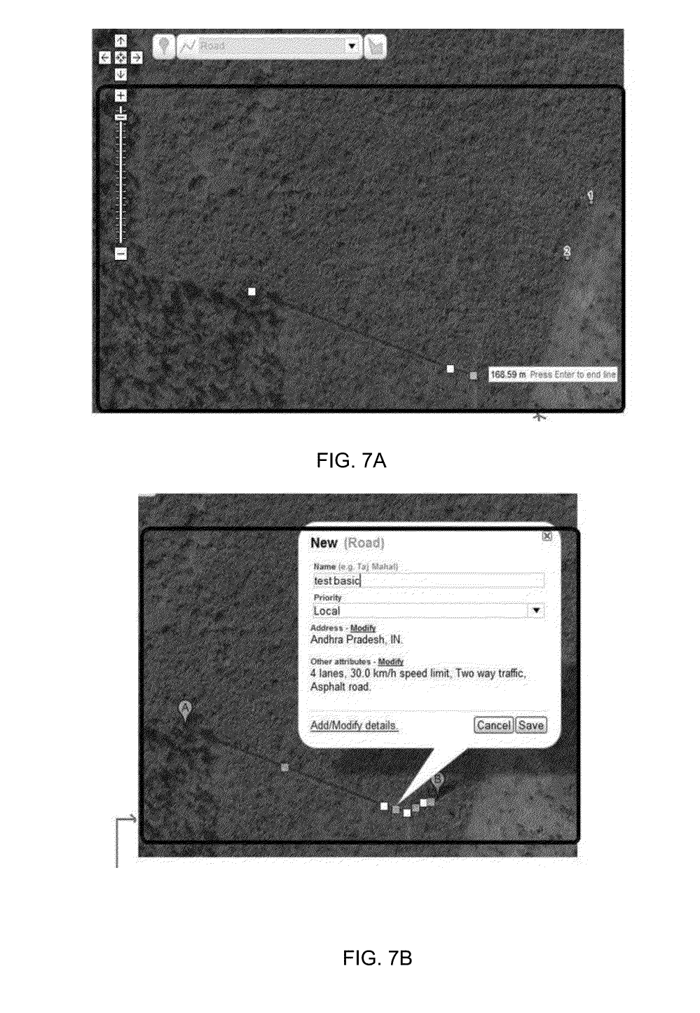

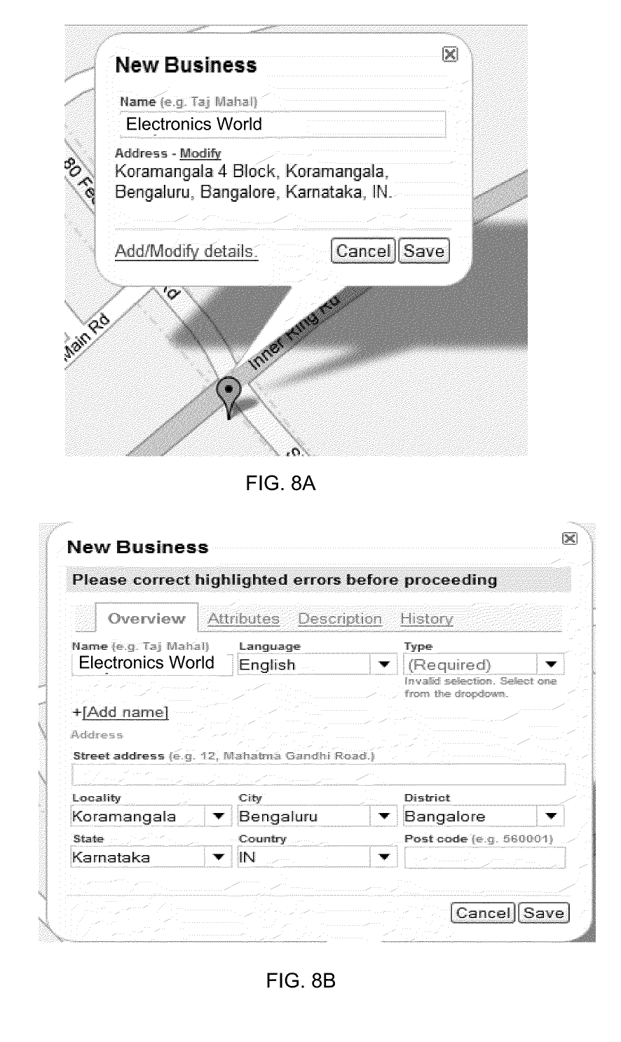

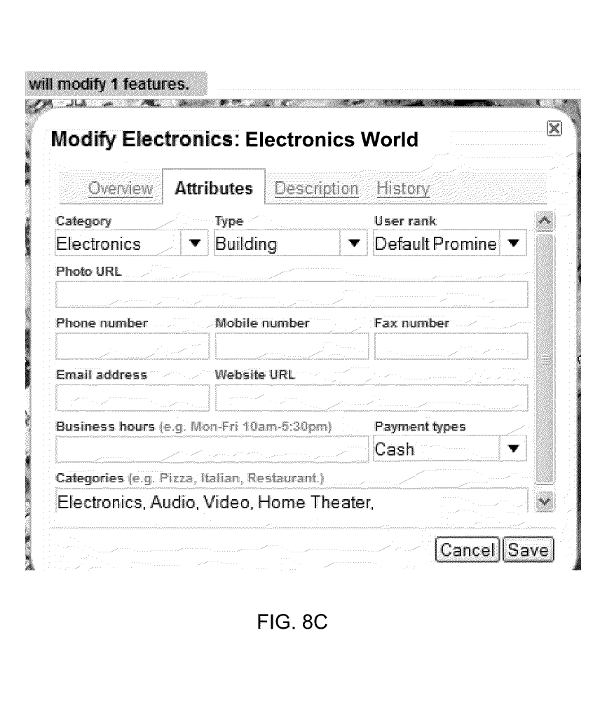

FIG. 7A illustrates one embodiment of an interface for specifying an edit adding a new road. Upon receiving a user's selection of a button for creating a feature represented by a line, the toolbar in the interface is expanded to reveal a drop down menu of feature types represented by a line. Prior to selection of the line button, the toolbar was a group of three smaller buttons of similar size depicting only the graphics for each type of feature—point, line and area. The user selects the type of map feature to add by choosing “Road” from the drop-down menu at the interface. The user then uses a mouse or other input device to draw a road on the map. FIG. 8A illustrates an embodiment of an interface for adding a new business, “Electronics World.”

The location of the edit is determined by the reverse geocoding engine 550. The inference module requests 510, from the reverse geocoding engine 550, the location of the feature being edited. The reverse geocoding engine 550 determines where the edit is located and what other features are near it using quadrants defined by geographic identifiers. The geographic identifiers for each quadrant are its latitude and longitude and its resolution (i.e., magnification) level. Therefore, each quadrant's geographic identifiers are unique.

The reverse geocoding engine 550 determines the location of the edit based on the latitude and longitude of the feature that has been edited. With the resolution of the map view on which the feature has been edited, the reverse geocoding engine 550 determines the quadrant identifier for the feature as well. The reverse geocoding engine 550 returns 512 the location of the edit to the inference module 110.

In order to determine what is near the edited feature, the inference module 110 searches 514 a map search index 570 for all map features that have the same quadrant identifier as the edited feature (“adjacent features”) as well as the attributes of those adjacent features. The map search index 570 is an index of all map data known to the GI system 100.

The inference module 110 applies 517 the rules that apply to edits for the type of feature being edited in the determined area and being near the determined adjacent features.

Based on the rules, the inference module 110 identifies 520 corrections that may be necessary to correct for any inaccuracy in the edit. Inaccuracy includes inaccuracy in placing a feature. For example, a user has added a road and the user's drawing of the road brings the added road very close to existing roads with which the added road likely intersects, but as drawn by the user, the new road does not intersect with the existing roads. The road engineering rules would detect this and indicate a correction is required. Road engineering rules can be programmed into the inference module 110 using known engineering models for roads. Alternatively or additionally, the inference module 110 derives road engineering rules statistically. This is accomplished when labeled examples of valid inferences based on road engineering rules are entered into the inference module 110. Discriminant functions and classifiers are derived using the labeled examples. Alternatively, functions are generated by fitting parameters on the labeled examples.

If corrections need to be made to the edit, the inference module 110 makes 522 those corrections in the next step. For the inaccuracy in the drawing of the added road above, the inference module 110 corrects the user's placement of the added road and extends the added road so that it does intersect with the existing roads.

The inference module 110 also identifies 525 additional changes to surrounding map data that are necessitated by a user's edit based on pre-programmed rules for types and attributes of features. For example, if a user has added a road that intersects correctly with some but not all existing roads, the inference module 110 identifies the roads that need to be extended to intersect with the added road.

The inference module 110 makes 527 additional changes made necessary by the user's edit. In the example of the added road that intersects correctly with some existing roads but not with another, the inference module 110 may extend the existing roads that should meet the added road rather than move the added road, if moving the added road would cause it to no longer intersect with other existing roads.

If there are competing modifications possible to an edit, the inference module 110 will return a question to the user to get clarity on the user's intent. Whether to extend an existing road or the road being added is determined by notions of user entered accuracy. When drawing a line, the user is more likely to be correct about the middle of the line but less likely to be precise on exactly where the line ends. For example, if a road is added and there are nearby roads which almost, but do not quite, end in the new road, or that cross the new road only by a few meters, it is assumed that the ends of the existing roads are less correct than the side of the new road. Therefore the inference engine will extend or shorten the existing road in order for it to terminate exactly in the new road. Conversely, if a new road is drawn to end just meters from an existing road instead of terminating at the existing road, it is assumed that the side of the existing road is more likely to be accurate than the end of the new road and the end of the new road will be extended to terminate exactly in the existing road.

The inference module 110 can also infer attributes of the edited feature. The inference module 110 makes these inferences based on the attributes of similar features that are near the feature being edited. These are analyzed through collaborative filtering. Additionally, the rules for attributes of map features can be applied when making inferences about the attributes of the edit. The attributes of adjacent features are returned 514 to the inference module 110 by the map search index 570. For features that are of the same type as the feature being edited, the inference module 110 assumes that the attributes of the edited feature are identical to the adjacent features. For example, if a new road is added and it intersects existing roads that are paved, the inference module 110 assumes the added road is also paved.

In the case of edits that are events, the inference module 110 can infer attributes of the event based upon the location of the event and the associated feature. Attributes of an event include the type of event and the prominences of the event. Event types include for example commercial, news, sports, historical, public, as well as accidents, road construction, weather, and so forth; the types of events are extensible by users as well as system administrators. The prominence of an event indicates in how large of a geographic area around the event users might be interested. Thus, for example, if the event is located at a city hall, the event is unlikely to be commercial but likely to be newsworthy, so the inference module 110 infers that it is a news event.

When displaying 530 the corrected edit to the user, the inference module 110 also shows the user the attributes that the inference module 110 has inferred about the feature being edited. These inferred attributes are displayed to the user in a dialog box. The user chooses whether or not to accept the inferred attributes or make changes to them.

Additionally, the inference module 110 may determine a confidence measure in the modification that the inference module 110 has made to the edit. Such a confidence measure is used by the SP module 120 as a risk signal. The lower the confidence measure of the modification to the edit, the higher the risk signal. The confidence measure can be based on the attribute being edited, the particular inference rules by the interference module, and the trust rating of the user. Edits having a confidence measure at or below a system administrator selected threshold value are set for further review by moderator, administrator, or other authorized user.

### Duplicate Detection

The inference module 110 can also detect duplications of features. For a given edit that is a new feature, the inference module 110 determines whether or not there is a duplicate of the feature by analyzing the names, types and attributes of features near the edit. Analyzing more than the name of the feature can be beneficial because name matching alone may not be an entirely reliable indicator of whether two features are the same, particularly where, for example, a given feature may have names in multiple languages, or even multiple names in a single language.

All features within a given radius of the edit are retrieved and ranked based on similarity and proximity to the edit. The attributes of the edit and the surrounding features are analyzed and the similarity is a function of the similarity of individual attributes or a combination of the attributes.

The radius to be searched is determined in part by a user indication of a geometric accuracy when entering the edit. In one embodiment, the user enters qualitative terms indicating a level of accuracy, such as “accurate,” “coarse,” or “very rough.” If the user has entered “accurate,” the search for adjacent features is limited to a small radius (e.g., 1 km), “coarse” will yield a larger radius (e.g., 2 km) and “very rough” an even larger radius (e.g., 5 km). Alternatively, the user can enter quantitative values for the accuracy, and these are used for the search radius.

The type of feature is useful in identifying duplicates, since multiples instances of some types of features are not likely to be near each other. For example, the user's edit may be to add an elementary school. If there already is an elementary school very close to the location at which the user is attempting to add another elementary school, the edit will rank highly as a possible duplicate. Conversely, if the edit is to add gas station and there are nearby gas stations, the new edit will have a low rank because it is not unlikely to have multiple gas stations close together.

The ranking can be accomplished by any ranking method known in the art including for example, weighted norm of order k. Any feature that exceeds a threshold score, Q, is marked as a potential duplicate. Those features which exceed a second threshold higher Q′, that is higher than Q, are marked as duplicates.

For features whose scores are between Q and Q′, the inference module 110 will prompt the user to indicate that the user's edit is a potential duplicate of an existing feature, and to confirm whether that is the case; the prompt preferably identifies the existing feature for the user's reference. If the user indicates that the edit is indeed a duplicate of the existing feature, the user's edit is merged with the existing feature and the user continues to make the edit to the existing feature. If the user indicates that the user's edit is not a duplicate, the edit is submitted as separate from the existing feature that is suspected to be a duplicate. That the edit is suspected to be a duplicate is taken into consideration by the SP module 120 when the reliability of the edit is determined. Provided that the user's trust rating is sufficiently high (e.g., >0.7), the edit may still be published without review. The trust rating of the user is described in further detail in reference to the operation of the SP module 120.

For an edit to an area on the map, duplication is detected in a similar manner to detecting duplications in points of interest. Instead of ranking edits by how far away existing features are, the features are ranked by the amount of overlapping area with the edit. Another measure of similarity for areas is how similar the shape of the area is. Because certain features can be represented both as points and areas, duplication detection takes into account nearby points in addition to areas. The distance from an existing point to the edit that is an area (or vice versa) is the distance from the center of the area to the point.

In order to detect duplication between features represented as lines on a map, only features of similar type are considered. For example, only other roadways will be considered when a road is added or edited. The overlap with each nearby feature of same type is computed and then aggregated. For lines, overlap is defined as the distance between the two lines being less than a given threshold. For each nearby feature, the proportion of the line that is overlapping is determined. The amount of overlap is scaled by the distance and/or the angle of the lines with respect to each other. The scaling may be accomplished by using the fraction rather than the amount of overlap. Alternatively a non-linear function of both measures is used. An example of a non-linear function is a weighted least squares of amount of overlap and the fraction of overlap. In scaling the amount of overlap, the parts of lines that are at sharp angles (e.g., <15 degrees) with respect to each other are ignored. When the amount of overlap exceeds a threshold, O1, the edit is marked as a potential duplicate. Upon the amount of overlap exceeding a second threshold, O1′, higher than O1, the edit is marked as a duplicate. From this point on the method proceeds as it does for duplicate detection for features that are points and areas.

The corrected edit with inferred attributes and any other changes along with possible queries to the user are displayed 530 at the browser 160 via the geo front end 103.

FIG. 7B illustrates a dialog box that can be shown to the user when an edit is returned by the inference module 110. In this example, the reverse geocoding engine 550 has located the road as being in Andhra Pradesh in India. The inference module 110 has inferred that it is a 4-lane asphalt road, with two-way traffic, and a 30.0 km/hr speed limit.

FIG. 8B illustrates that reverse geocoding engine 550 has located Electronics World in Koramangala in the city of Bengaluru in the district of Bangalore in the state of Karnataka in India. The user has neglected to enter the business type and the inference module has returned an error requesting this information from the user.

FIG. 8C illustrates the attributes of Electronics World should another user go to modify the recently added Electronics World.

The user will choose whether to confirm the corrections and inferences made by the inference module 110. In one embodiment, the system will not accept edits if the user does not confirm changes from the inference module 110 that were necessitated by the rules. For example, an edit by a user may be the addition of a road that is drawn as a spiral. As drawn, the road violates the civil engineering rules. If the user does not accept the changes made by the inference module 110 that would bring the road into compliance with the rules, the system will discard the edit if the user submits the edit without the changes.

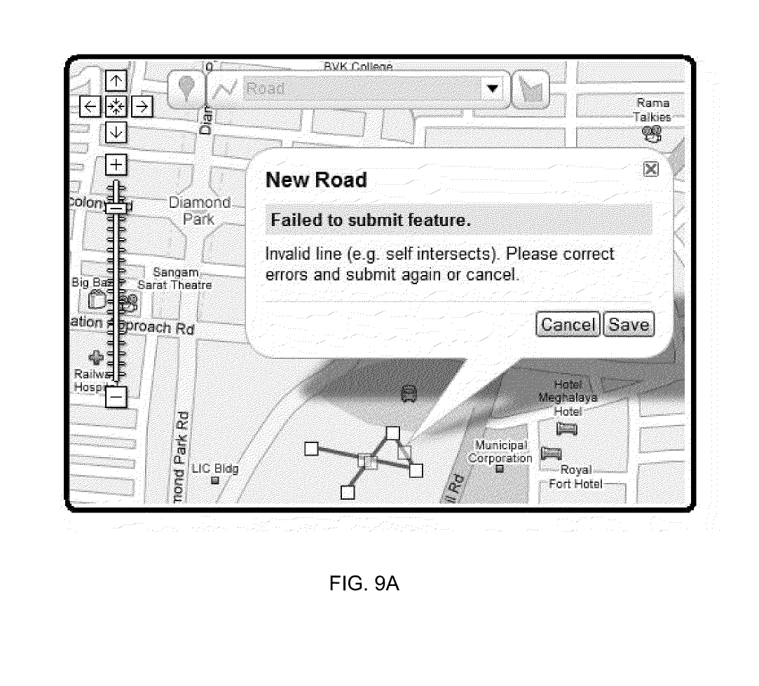

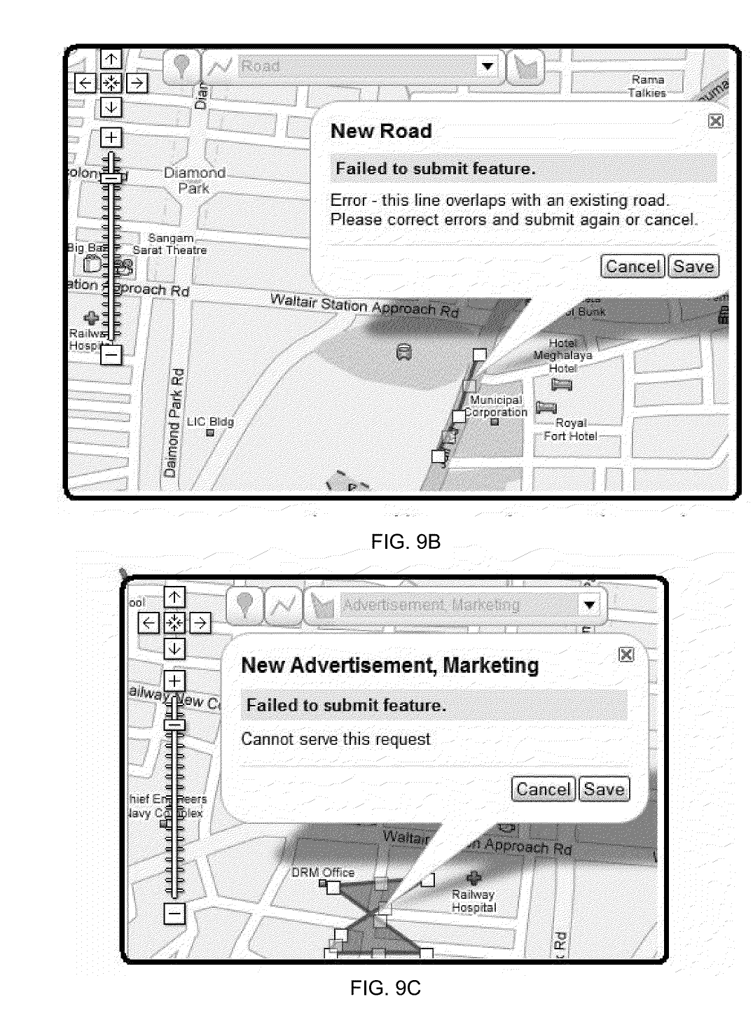

FIG. 9A is an illustration of a road that has been drawn in violation of the civil engineering rules for roads. The road intersects itself. The inference module 110 has generated a text representation of the error and returned that to the user.

FIG. 9B illustrates another example of an error. The new road has been drawn so that it overlaps with an existing road. This also violates the civil engineering rules for roads and therefore the inference module 110 has returned the edit to the user for correction.

FIG. 9C illustrates an example of an error in adding a building. The building has been drawn in such a way that it violates the rules and therefore the inference module 110 has returned the edit to the user for correction.

### Adding Transient Edits

A transient edit is an edit that is in place temporarily. Transient edits can be a temporary change in the attribute of a feature, an event at a feature, or a whole feature being present or absent. Examples include a temporary change to the business hours of a store, a circus at a local park for a week, or a particular show at a theater. Transient edits are indexed by a time key that indicates to the system when the edit should appear and when it should be removed again. The time keys are scanned regularly. When a transient edit is to be added or removed the change is applied in the same manner as individual changes and edits added by users. The method of applying transient edits facilitates the adding of events as most events are likely to be temporary.

### Multiple Edits to a Feature

In one embodiment, one user editing a feature locks that feature and prevents other users from making additional edits to that feature until the first edit is either accepted or discarded.

Alternatively, multiple simultaneous edits to a feature or to adjacent features are allowed. The GI Server 105 manages the multiple edits using a hierarchy of dependency rules. The storage of edits uses a differential data structure which includes the difference between the existing feature and the edited feature, the differential. For example, if the edit made by a user were the increase of the speed limit on a given road, rather than storing the edit as the name, road surface, number of lanes, speed limit, etc., the information about the edit stored would include that the speed limit changed from its prior value to the updated value (e.g., 35 MPH to 45 MPH). This allows the system to determine whether or not this edit is dependent on another edit to that feature.

In one embodiment, the dependency rules are based at least in part on the semantic dependencies of the attributes of a feature, as described above. Generally, if two (or more) edits to a feature are edits to attributes where one of the attributes is semantically dependent upon another, the GI Server 105 allows the edits to proceed first with the edit(s) to the attribute(s) that are not semantically dependent, and then with the edits that are to the dependent attributes. The remaining edits can be processed in an order that resolves the remaining dependencies so as to maintain the integrity of each edit, by avoiding overwrites or other data corruption. The resolution of these types of data dependencies can be determined based on the outcome of each edit.

To determine the outcome of each edit and therefore whether or not there is a data dependency between two edits, the differentials of edits are compared. If applying the second edit were to cause the first edit to be corrupted, there is a dependency between the two edits. Additionally if the second edit were to be applied but then the first edit could not be applied or not reverted after being applied without corrupting the data or changing the semantic value of either edit, there is a dependency between the two edits.

Generally, if there is no semantic dependency between a first and second edit to the same feature, the second edit may be published before the first edit is resolved. For example, if the first user is changing the telephone number for a store and a second user is adding a sale event to the store, the addition of the sale event is not semantically dependent upon the store's telephone number. Therefore, the addition of the sale event to the store goes forward independent of the change of the store's telephone number.

If there is a semantic dependency between two edits, the second edit is considered to “float,” waiting for resolution of the first edit, and the first edit is a blocking edit to the floating edit. An example is a first user editing the attributes of an existing road and a second user adding a new road that will intersect with the existing road. Because the system infers the attributes of a new road from the roads with which the new road intersects, the addition of the new road is dependent upon the edit to the existing road. The second edit will not be considered for publication until the first edit is either accepted and published or discarded.

For this example, the floating edit will be considered regardless of whether or not the blocking edit is accepted. The floating edit, if accepted and published, will have different attributes depending on whether the blocking edit is accepted or not because the attributes of the new road are inferred from the existing road with which the new road intersects.

In some cases of semantically dependent edits, however, the publication of the blocking edit makes the floating edit moot and the floating edit is discarded upon acceptance of the blocking edit. For example if a first user is deleting a store because it has just gone out of business, a change for the store's phone number being added by a second user is moot if the first edit is accepted; thus the floating edit of the second user is discarded and not published. If however the blocking edit were not accepted, the floating edit would go forward and be considered.

The information relevant to creating the hierarchy of dependencies includes for any given floating edit, the time the floating edit was made; time constraints if any; the blocking edit upon which the floating edit depends; what resolution of the blocking edit means for the floating edit; and revert constraints. The time constraints include the time(s) that the floating edit should not be applied. Time constraints may be represented as time stamps. Similarly revert constraints indicate when the floating edit, if it is applied, should be undone. These would be relevant to a floating edit that is a transient edit. An example would be an event which would expire at a particular time.

To keep track of dependencies, dependencies are indexed in an inverted index, where the indexed objects are the floating edits, and the index terms are the ID's for the blocking edits and the blocking time. The index supports a query to return all floating edits that depend on a given blocking edit or done at a given time. Additionally, the index supports a query to return all the blocking edits for a given floating edit. In addition to an index, this can be performed using a table lookup or SQL query.

To propagate the floating edits, when an edit is resolved the dependency index is queried for floating edits that depend on the edit. Those floating edits are retrieved. For each floating edit, if all blocking edits for that floating edit are resolved, the floating edit is processed as any other edit.

### Operation of the Spam Prevention Module

The SP module 120 determines a reliability score (R) of the proposed edit with the spam prevention model based on the risk of the feature being edited and the trust of the user making the edit. Those edits that are determined to be reliable are published without delay. Those edits determined not to be reliable are sent to the reviewing module. The spam model combines the risk, trust and a temporal suppression factor to determine R. The temporal suppression factor determines whether or not the session during which the user proposed the currently proposed edit was similar to the editing patterns of that user.

### Determination of Risk

Each edited feature has a risk associated with it. In one embodiment, there are four categories of risk: low, moderate, high and very high. Alternatively, risk is a number that is continuously variable, such as between 0 and 1. The higher the risk for a given feature, the more likely it is that an edit to that feature or the addition of the feature is inaccurate. Risk is determined from a number of risk signals, based on information about the feature being added or changed and the region around it. In one embodiment, risk signals include: data density, data type and rank.

Data density refers to the density of other features around the feature being edited. A higher density in the area around an edited feature results in a higher risk signal, because it is less likely that a feature is missing or inaccurate. For example, it may be less likely that a road is missing on a map of central Amsterdam than that a road is missing from a map of a new suburb miles outside Des Moines, Iowa. Because it is less likely that the road is missing from central Amsterdam, it is more likely that a new road in that area is inaccurate. Additionally, higher density in the area around an edited feature may correlate to a larger number of requests for maps of that area. More users would thus be misled by an inaccurate edit. For this reason, too, adding or changing a feature in a dense area results in a higher risk signal for that edit.

Data type refers to whether or not the feature being edited or added is commercial. If the feature is of a commercial nature, it is more likely that it will be altered inaccurately, and therefore the risk signal is higher than for a non-commercial feature. There may be more incentive to add inaccurate information about a store than about a park. For example, a store owner could gain financially if the store owner were to change the address of a competing store to the wrong address. There is less analogous financial incentive to change the address of a non-commercial feature.

A third risk signal is the visibility rank of the edited feature. A feature's visibility rank corresponds to the degree to which the public is aware of the feature, or its visibility to the public; the visibility rank may be considered as a measure of the importance or significance of the feature. The higher a feature's visibility rank, the more likely it will be altered inaccurately. High visibility rank features include features that are famous or have high levels of public awareness associated with them. The motivation for an inaccurate edit to a high visibility rank feature could be financial but could also be malicious or mischievous. An example of a feature with a high visibility rank is the Eiffel Tower. Because it is famous and recognized by many people around the world, it has high significance and therefore high visibility rank. There may therefore be more motivation to make inaccurate edits to the Eiffel Tower—for example, to remove or rename it—than to a landmark building in a small town. However in that small town, there is still more motivation to make inaccurate edits to a landmark building in that small town than to an individual residence. Therefore, the Eiffel Tower has a higher visibility rank and therefore higher risk signal than the landmark building in the small town which in turn has a higher rank and therefore higher risk signal than a private residence in that town.

Visibility rank may also be entered by a user. The more trust the user has, the more weight a user's determination of visibility rank is given.

Additional factors in determining rank may include whether the feature is visible from a high rank feature, whether the feature can be accessed from a high rank feature (i.e. via public transportation or on foot or in a car), the size of the feature, and how far the feature is from a high rank feature.

Additionally or alternatively, all of the risk signals may be taken into account to generate an overall risk signal. A hierarchy of relationships between the risk signals is found by determining the association between signals either manually or automatically by correlation. The resulting hierarchy has the risk signals in order based on the specificity and importance of each signal. The associations are determined in a manner that minimizes double-counting of an individual risk signal. The risk signals are combined using any risk combination model. Examples of risk combination models include simple weighted risk aggregation and thresholding, eigenvector analysis and large margin classifiers. In an alternative embodiment, an additional risk signal from the individual risk signals is generated that is considered together with the individual risk signal rather than as a replacement for the individual risk signals.

The hierarchy may also be used to generate a text representation of the risks. This text representation is presented to the users of the map. This is beneficial because it communicates to moderators the risk that the system determined in the edit and the moderator can take that into consideration in reviewing the edit. This feature also communicates how the system works to users to give them insight and instill their confidence in the system.

As described previously, the inference module 110 may determine a confidence measure in a modification made to an edit and this confidence measure is used as an additional risk signal.

The following table shows an example of criteria for each level of risk. In the table, C=degree of commerciality of the proposed edit and U=user value of the proposed edit.

| | |
|---|---|
| 0 < Risk < 0.1 | => Nice to have data, no C, low U |
| 0.1 ≦ Risk < 0.2 | => useful to have data, no C, low U |
| 0.2 ≦ Risk < 0.3 | => useful data, low C/moderate U |
| 0.3 ≦ Risk < 0.4 | => low C, dense area, moderate rank/moderate U in |
| | dense areas |
| 0.4 ≦ Risk < 0.5 | => moderate C/moderate U in dense areas, moderate |
| | rank/High U |
| 0.5 ≦ Risk < 0.6 | => moderate C, dense area/moderate U in dense |
| | area, moderate rank/High U |
| 0.6 ≦ Risk < 0.7 | => moderate C, dense, moderate rank/Moderate U |
| | in dense area, high rank/High U in dense area |
| 0.7 ≦ Risk < 0.8 | => moderate C, dense area, high rank/High U in |
| | dense area, moderate rank/Sensitive |
| 0.8 ≦ Risk < 0.9 | => High C, dense area, moderate rank/High U in |
| | dense area, high rank/Sensitive in dense area |
| 0.9 ≦ Risk < 0.99 | => High C, dense, high rank/High U in dense area, |
| | high rank/Sensitive in dense area, high rank |

### Determination of Trust

The assessment of trust for the spam prevention model is an assessment of the user who made the proposed edit. In one embodiment, users are given a trust rating (T)—for example, a number on a scale of 0 to 1. In one embodiment, the user has an overall trust rating as well as a trust rating for individual geographic regions and/or types of map features that they edit. The signals taken into account when assessing the trust rating for a given user can include, about that user, the number of previous edits made, the number of times a previous edit has been viewed by other users, the number of previous edits that have been reviewed, reviews of previous edits, rating of reviewers that reviewed the edits (“r”), the number of edits that the user reviews in comparison to how many edits the user makes, whether or not the reviewer marked the edit as being a quality edit, number of continuous approvals (“c”) and the number of continuous approvals without interruption where at least twenty percent of the approvals mark the edit as being a quality edit (“chi”). Edit quality is discussed in greater detail in reference to FIG. 6. Users who also review edits have a trust rating relating to their review of edits. The user's review trust rating further takes into account the number of edits reviewed and how a later reviewer rated edits that required additional review beyond the user's review.

Actions by other users are taken into account as unsolicited reviews. Examples of such actions by other users include a view (“v”) and a tacit approval (“t”). A view is a user requesting a search that returns the edited feature as part of the search results or in which the edited feature is in the map view that is returned in response to the search query. A tacit approval is a view where the user has also clicked on the edited feature. In determining a user's rating, a number of views can be set to have the same value as a single tacit approval. Additionally or alternatively, a certain number of tacit approvals can be assigned the same value as an approval solicited from a reviewer by the reviewing module 125.

An example of a trust rating system described above would be organized as follows. Reviews solicited by the reviewing module 125 are either from a fellow user (“peer reviewer”) or from a moderator where the approval by a moderator (“m”) carries more weight than the approval of a peer reviewer (“p”). After 50 edits are approved by a moderator, two approvals by a peer reviewer count as one moderator approval. Additionally five tacit approvals count as one peer reviewer approval and ten views count as one tacit approval. The following table shows the criteria for each of the trust ratings:

| Trust Rating | Criteria |
|---|---|
| 0.05 | Default |
| 0.1 | >50 edits, >10m |
| 0.2 | >100 edits, >20m |
| 0.3 | >200 edits, >35m |
| 0.4 | >400 edits, >50m |
| 0.5 | >400 edits, >50m |
| 0.6 | >2000 edits, >150m, >10% r |
| 0.7 | >3500 edits, >300m |
| 0.8 | >7000 edits, >450m, >100c |
| 0.9 | >14000 edits, >600m, >50chi |
| 0.99 | >14000 edits, >600m, >200chi |

In another embodiment, the trust is determined from information about the user learned through the user's interaction with other applications related to the system. For example, if a user has used other applications such as a weblog or message board, the SP module 120 accesses the user's history of those other applications for use in the spam model. The history will indicate if the user has made mischievous or malicious postings to a weblog or message board. If the user has a history of mischievous or malicious actions on other applications, this reduces the user's trust rating in the spam model.

Alternatively or additionally, a user's trust rating is influenced by the IP address of the user's computer. If many mischievous or inaccurate edits have come from other users at that IP address, the trust rating for all users from that IP address may be reduced.

### Comparison of Risk and Trust

The spam model compares risk R and trust T to determine an initial reliability score (“IR”). The maximum IR score is 0.99. The maximum reliability score is assigned if trust T exceeds risk R by a threshold amount. An example is T≧(Risk+0.2) where Risk>0.

### Determination of Temporal Suppression Factors

A third type of signal that can be taken into consideration by the spam model are temporal suppression factors. The first of these is the habit factor (“H”), which is a comparison of the patterns of making edits that the user has established in the past with the manner in which the same user made the currently proposed edit. The patterns of the individual user include how many edits a user makes on average per day and per hour and average edits per day and per hour on a day or in an hour when the user is actively making edits. This information about each user is stored in the GI database 165. H can be represented as number between 0 and 1 that, when multiplied by the IR, reduces the final R from the initial IR. If a user's pattern during the session in which they proposed the current edit is similar to their established pattern of making edits, H will be close to one and the final R will not be much less than IR. The pattern from the session of the current edit is considered to be similar to the established pattern if it is within three standard deviations of the established pattern. It is calculated as follows:

In one embodiment, H=(1−(E−E−_{avg})/3σ+0.01) where E is the number of edits made in the session in which the current edit was made and E_{avg} is the average number of edits made in a session for that user. If the number of edits made in the session in which the current edit was made exceeds the average by four standard deviations, H automatically becomes 0. E can also be the number edits per hour, per day, per active hour, per active day. If E for the current session exceeds four standard deviations for any of the statistics tested, H becomes 0. The result is that the proposed edit is determined not to be reliable and is sent to the reviewing module.

H becomes less important and is therefore given less weight as a user's trust T increases. At a given threshold of trust T, H is suppressed by 50% (i.e., multiplied by a 0.5 scaling factor) and this suppression may be increased to 99%. Under these circumstances, the initial reliability determination, IR is given more weight in the final determination of R.

A second temporal suppression factor that can be taken into account is the human limits factor, HL, which represents threshold values for how many accurate edits a human being can make in a given period of time. In one embodiment, those HL threshold values are two or more accurate edits in a minute, ten or more accurate edits in ten minutes and forty or more accurate edits in one hour. If the number of edits made by the user during the session in which the proposed edit was made exceeds the HL threshold value, the edit is determined to be unreliable, regardless of the trust, risk and habit determinations. To determine thresholds, prior data and system limits such server response times are analyzed to determine, for example, that a user enter n new features per minute.

Additionally, how many previous edits a user has of a given map feature type is taken into account by the SP module 120. At HL threshold numbers of edits of a given type, IR cannot be greater than threshold values. In one embodiment:

| Number of edits of a given type | IR |
|---|---|
| <3 | =0 |
| <10 | <0.5 |
| <20 | <0.75 |

### Operation of the Review Module

Proposed edits are stored in a moderation queue and ranked according to the type of feature being edited, the amount of time since the edit was proposed, the trust rating of the user proposing the edit and the rank of the feature. Blocking edits are ranked higher in order to allow for resolution of the floating edits they are blocking Older proposed edits are ranked higher than newer proposed edits. Proposed edits to higher ranking features are ranked higher in the moderation queue than proposed edits to lower ranking features. Proposed edits that have been moderated once but have not been definitively approved or denied are also ranked higher. The fact that the proposed edit was assessed by a first reviewer and thus was of some interest or value to that reviewer indicates that the proposed edit is of value to the community and thus having it definitively approved or denied is of value.

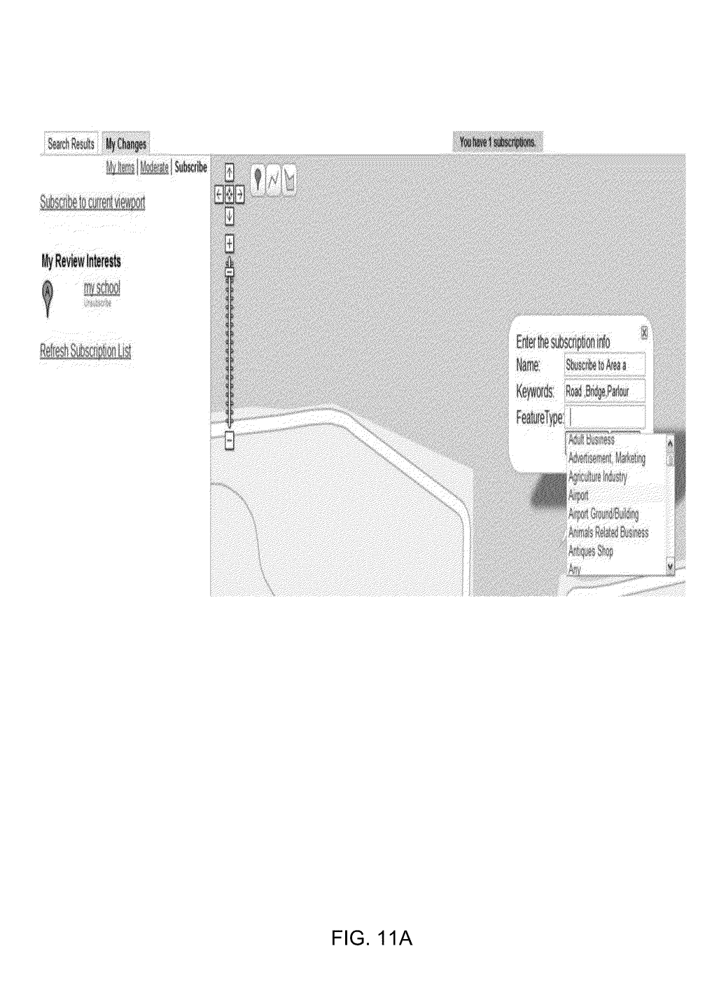

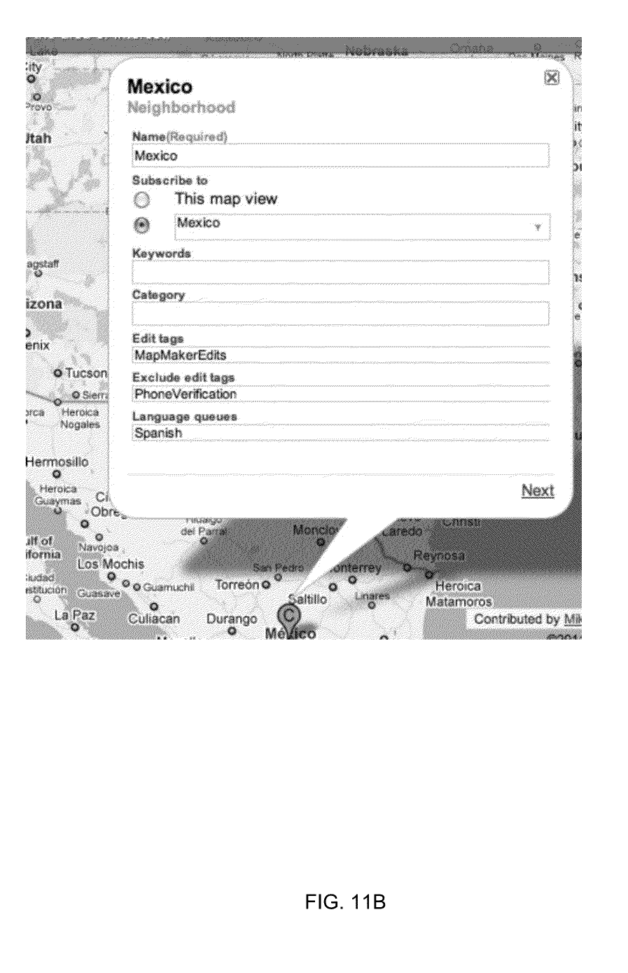

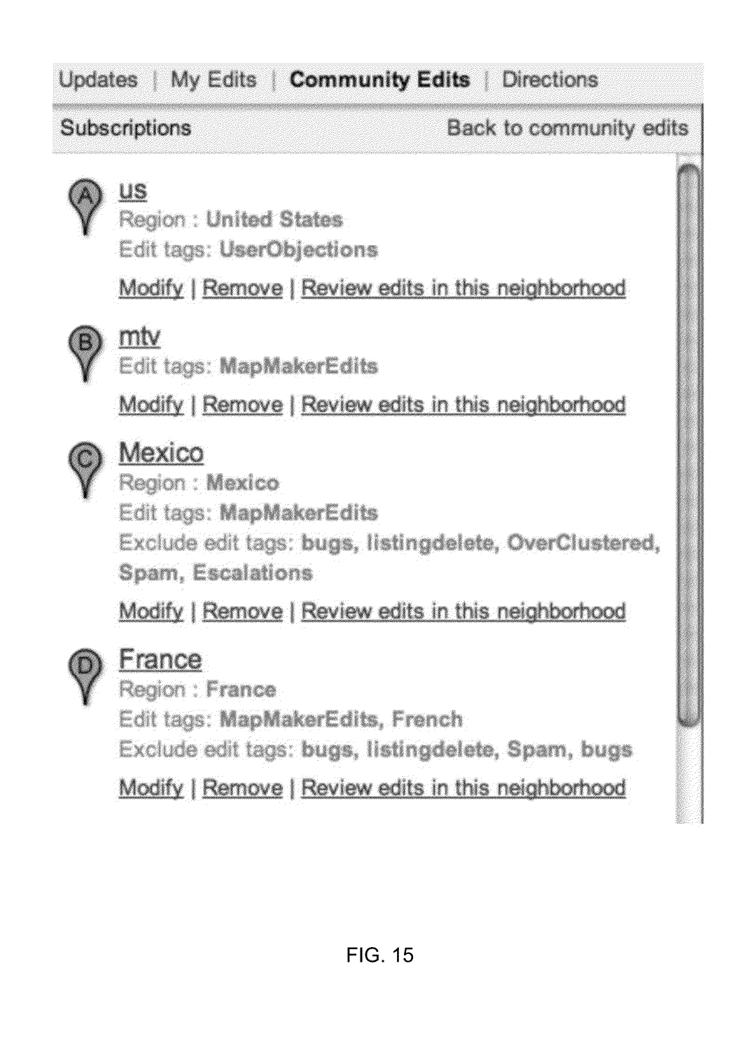

FIG. 10 is a sequence diagram illustrating a method of reviewing edits according to one embodiment. The reviewing module 125 determines 1043 the reviewer based on a reviewer's subscription. Reviewers subscribe to review proposed edits in a particular geographic area and/or particular types of features. For example, a reviewer subscribes to review proposed edits in the area where the reviewer lives currently, where the reviewer has traveled and/or where the reviewer has lived in the past. FIGS. 11A-11B are illustrations of dialog boxes a reviewer would use to subscribe to review proposed edits fitting certain criteria. The tags associated with the proposed edits are used to determine whether the proposed edits meet the criteria. If the proposed edit meets the criteria for the reviewer, an additional tag is added to the proposed edit's record; this tag can be a unique identifier associated with the reviewer. A reviewer's subscription results in a logical sub-queue of proposed edits for that reviewer. A proposed edit may be associated with multiple different reviewers. FIG. 15 illustrates a list of a reviewer's subscriptions of proposed edits to moderate.

If the proposed edit meets the criteria for the subscriptions of other reviewers, additional tags are associated with the proposed edit for those additional reviewers, thereby associating the proposed edit with the sub-queues of these individual reviewers. The token for the proposed edit review token table 475 for the proposed edit keeps track of whether the proposed edit has been reviewed. If it has, the proposed edit is removed from the sub-queue for the additional users whose subscriptions match the proposed edit.

Reviewers can share their subscriptions with other reviewers. Upon sharing a subscription with a second reviewer, the proposed edits matching the criteria of the subscription are tagged as being in the sub-queue for the second reviewer. For example, if a first reviewer chooses to moderate proposed edits for pancake houses in Amerongen in the Netherlands, sharing that subscription with a second reviewer results in proposed edits to pancake houses in the Amerongen being tagged for inclusion in the sub-queue for the second reviewer as well. Optionally, filters are applied to the shared subscription in the second reviewer's subqueue. For example, if a particular proposed edit to a pancake house is considered too high risk relative to the second reviewer's trust rating, that one proposed edit will not be tagged for the second reviewer.

The reviewing module 125 requests 1035 a reviewer from the geowiki librarian 483 whose subscription matches the location of the proposed edit. The geowiki librarian 483 returns 1037 a list of one or more reviewers whose subscription coincides with the location of the proposed edit.

In one embodiment, any user can be a reviewer for proposed edits by other users. Alternatively, moderators who are experienced reviewers might be employed for the purpose of reviewing proposed edits. In yet another embodiment, there are reviewers at a plurality of levels of expertise. The reviewer's level of expertise is determined relevant to a geographic area as well as for types of map features being edited. Any other attribute or characteristic of the proposed edits and map features being edited can be used to filter and determine a specific level of expertise. The reviewer's level of expertise is determined using metadata that has been collected about that reviewer. Such information is stored in a user data table 1077. The user data table 1077 is housed in the GI database 165 and stores metadata about all users. Metadata about users stored in the user data table 1077 includes previous edits a user has made, previous edits a user has reviewed, and whether or not edits made or reviewed by a user were later changed. In one embodiment, the reviewer's level of expertise is the reviewer's trust rating—either the global trust rating or specific to a geographic area or type of map feature being edited. As a reviewer's trust rating increases, the reviewer is promoted to a higher level of expertise. Optionally, prior to promoting a reviewer to a higher level of expertise, the reviewer is sent a message asking of the reviewer to approve the promotion. A reviewer having a specific level of expertise can result in a subscription to the proposed edits that match the criteria for the user's level of expertise.

Alternatively, the reviewing module 125 determines 1043 reviewers for an individual proposed edit by assigning the proposed edit to a reviewer based on the metadata that has been collected about that reviewer. For example, if the reviewer has reviewed many edits in a given area and those edits when published were rarely later changed, the reviewing module 125 assigns future proposed edits in that area to that reviewer.

In one embodiment, the user's trust rating is compared to the risk of the proposed edit. The higher the risk of the edit, the higher the trust rating needed for the reviewer reviewing the proposed edit. If a user has subscribed to certain edits, those edits that meet the subscription but have a risk that exceeds the allowable risk based on the user's trust rating, that edit is not tagged as included in the reviewer's subqueue. Thus the reviewer's trust rating is applied as an additional filter on the proposed edits provided to a reviewer for review.

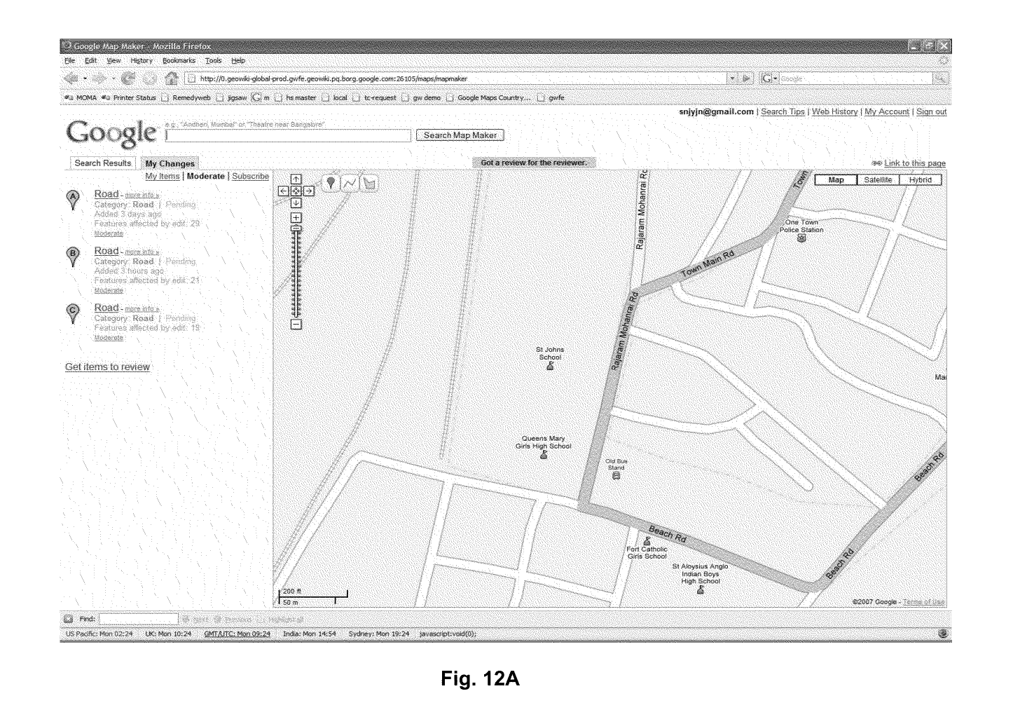

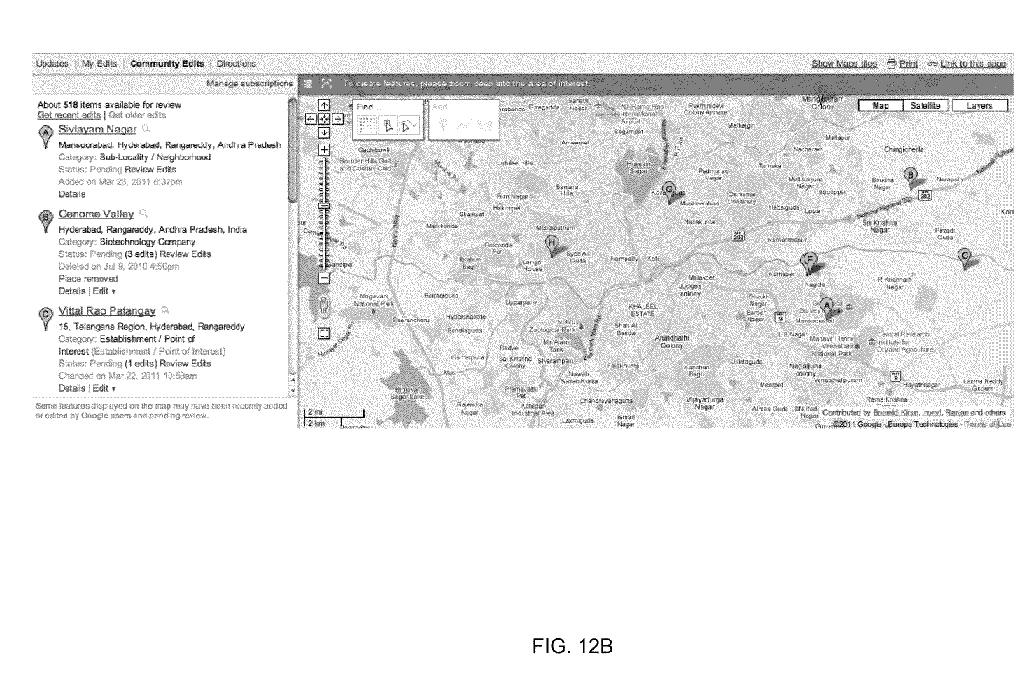

After one or more reviewers have been determined for the proposed edit, the reviewing module 125 notifies 1044 each such reviewer that there is a proposed edit waiting to be reviewed. In one embodiment, a reviewer receives an email with a list of proposed edits for the reviewer to review. Alternatively, a reviewer logs in to a web page that has a list of proposed edits for the reviewer to review. FIGS. 12A-12B are examples of the browser window showing the list of edits that have been assigned to the reviewer for review.

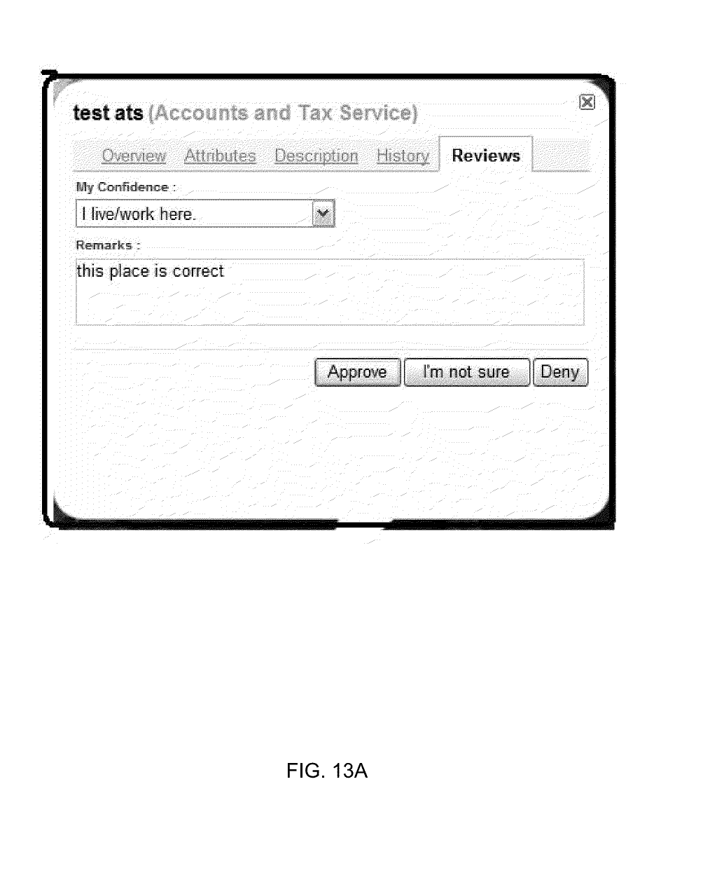

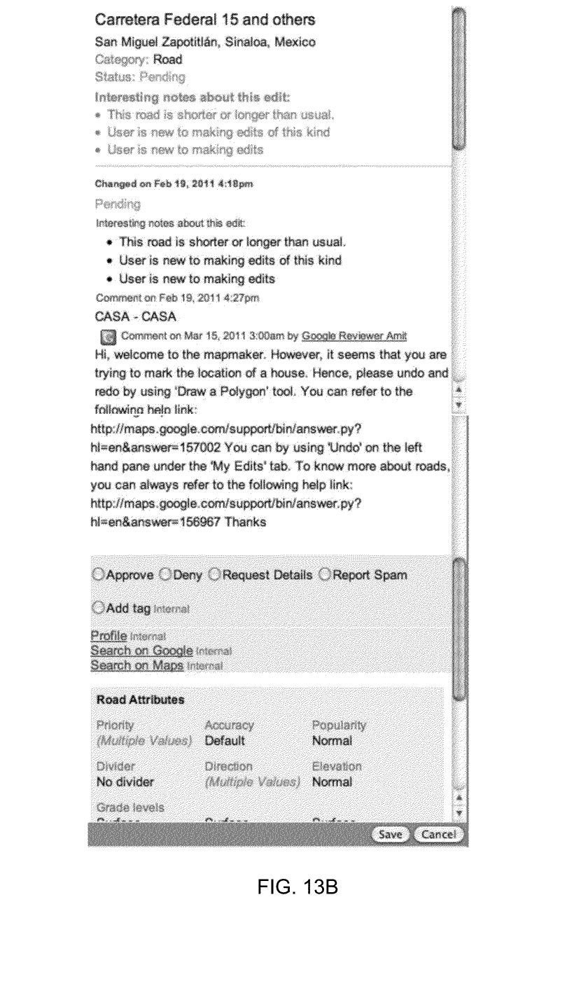

After the reviewer has reviewed the proposed edit, the reviewing module 125 receives 1045 the reviewer's feedback of the proposed edit from the geowiki librarian 483. A reviewer's feedback of a proposed edit includes whether or not the proposed edit is accurate (e.g., approval or denial of the proposed edit). FIG. 13A is an example of a dialog box for the reviewer to provide the reviewer's feedback about an edit; the reviewer can approve, deny or indicate that they are not certain whether the proposed edit is correct. FIG. 13B is another example of a dialog box for the reviewer to provide feedback. In this example, one other reviewer has already added a comment to the edit. Additionally or alternatively, an edit is evaluated for being a quality edit. A quality edit is one that is not only accurate but is of quality. For example, the feature added follows the underlying satellite imagery closely. Additionally, the feature is in consonance with the nature of the area. Additionally, a reviewer can indicate that additional information is requested from the author of the proposed edit, indicate that the reviewer would like an additional reviewer's input. The reviewer's actions result in a tag indicating that action being added to the proposed edit.

The feedback received about the proposed edit is sent 1046 to the user data table 1077. The information sent to the user data table includes the reviewer or reviewers of the proposed edit, the user who made the proposed edit and the content of the reviewer's feedback about the proposed edit.

The reviewing module 125 determines 1047 the accuracy of the proposed edit based upon the feedback received from the reviewer or reviewers. For example, the reviewing module 125 can determine the proposed edit to be accurate in response to a majority (or supermajority) of reviewers approving the proposed edit. Alternatively or additionally, collaborative filtering is used to determine if the attributes of the edited feature and the surrounding features are consistent. Accurate proposed edits are marked 1050 for publication. Submitted edits that are determined not to be accurate are discarded 1055. Whether a proposed edit was published or discarded is sent 1060 to the user data table 1077 for future reference about the user who proposed the edit and the reviewer or reviewers who reviewed the proposed edit. In one embodiment, the reviewing module 125 notifies 1062 the user of the proposed edit whether the user's proposed edit will be published or discarded.

### Incentivizing Reviewers to Moderate

In an embodiment with volunteer reviewers, providing incentives for reviewing edits is useful in efficient processing of proposed edits. Often reviewers are also submitting edits of their own. For such reviewers, increasing the rank of their proposed edits in the global moderation queue in response to the reviewer reviewing proposed edits is one way to incentivize the reviewer to review more edits. Increasing the rank of a reviewer's proposed edits can be done based on an absolute number of proposed edits reviewed by the reviewer or on a ratio of proposed edits reviewed to the proposed edits proposed, a combination thereof or other similar measures of productivity and quality. The more proposed edits the reviewer reviews for each proposed edit proposed, the higher the rank in the moderation queue of that reviewer's proposed edits. Additionally or alternatively, a reviewer's proposed edits are increased in rank in the moderation queue if the reviewer provides more detailed comments (for example in the Remarks box in FIG. 13A) when moderating proposed edits.

### Operation of the Publishing Module

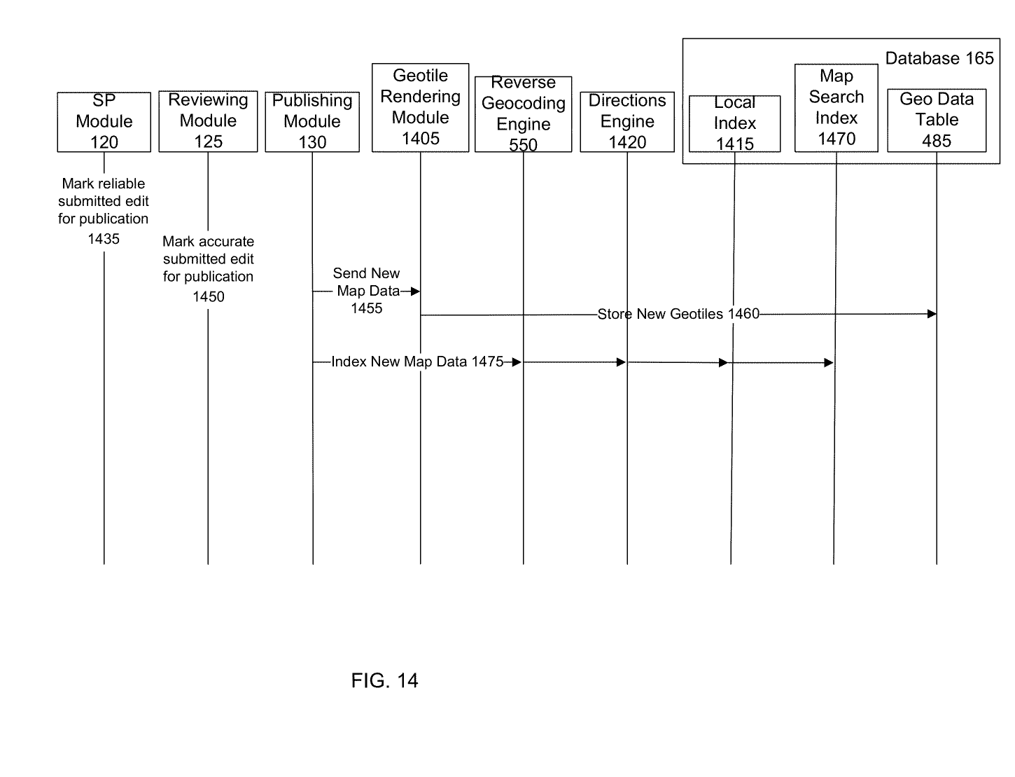

FIG. 14 is a sequence diagram illustrating a method of publishing edits according to one embodiment. Submitted edits are marked 1435 for publication by the SP module 120 when proposed edits are determined to be reliable and do not require review. Additionally or alternatively, proposed edits are marked 1450 for publication by the reviewing module 125 after they have been determined to be accurate.

When a proposed edit is published it becomes map data and is added to the core geo tile or geo tiles for the area of the map in which the proposed edit is located. The publishing module 130 sends 1455 the proposed edit to the geo the rendering module 1405. The geo tile rendering module 1405 renders one or more replacement geo tile(s) for the area of the map affected by the proposed edit. Preferably, geo tile rendering module 1405 renders the new geo tile(s) substantially immediately after receiving it from the publishing module 130, that is, rendering it as soon as possible, given computational loads and any other proposed edits that have been queued for rendering. In this embodiment, the geo tiles are preferably rendered within one to two minutes of being received from the publishing module 130. Alternatively, the geo tile rendering module 1405 renders new geo tiles in batches. In an embodiment where geo tiles are rendered in batches, new geo tiles displaying newly published edits are rendered within four hours of the proposed edit being published. The resulting geo tile(s) are stored 1460 in a geo data table 485.

The geo data table 485 stores all geo tiles as well as all map data. In a preferred embodiment, three versions of a tile are being served at one time by a serving module. Those three versions differ temporally. The three versions include the most up to date version and two earlier versions. Alternatively more than three or fewer than three versions of core geo tiles are served at one time.

Additionally, the published edit is indexed 1475 by the publishing module 130 to the map search index 1470, the local index 1415, the directions engine 1420 and the reverse geocoding engine 550.

The directions engine 1420 generates directions from one location to another upon request by a user. Directions engines are well-known in the art. When a published edit is indexed into the directions engine 1420, it is available as necessary for generating directions for a user.

The local index 1415 is the index for businesses. The local index 1415 is analogous to a yellow pages. If the published edit refers to a commercial or business feature, it is indexed to the local index. The published edit can then be located by users entering a search query for businesses in an area.

In another embodiment, users can request automatically generated newsletters. The user subscribes to a certain geographic area and may specify certain types of features. They will receive all the changes to and additions of map features meeting the specified criteria.

Additionally, web pages are generated for individual features. The web page can display all of the information about the feature. Alternatively, the web page displays the information of greatest interest to a particular user. What is of interest to a particular user is determined from the user's profile.

The present invention has been described in particular detail with respect to several possible embodiments. Those of skill in the art will appreciate that the invention may be practiced in other embodiments. First, the particular naming of the modules, capitalization of terms, the attributes, data structures, or any other programming or structural aspect is not mandatory or significant, and the mechanisms that implement the invention or its features may have different names, formats, or protocols. Further, the system and the individual modules may be implemented as either software code executed by the computer system, or as hardware elements with dedicated circuit logic, or a combination of hardware and software. Also, the particular division of functionality between the various system components described herein is merely exemplary, and not mandatory; functions performed by a single system module may instead be performed by multiple modules, and functions performed by multiple modules may instead performed by a single module.

Some portions of above description present the features of the present invention in terms of methods and symbolic representations of operations on information. These descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet, public networks, private networks, or other networks enabling communication between computing systems. Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A computer-implemented method for moderating proposed edits to a map comprising:
storing a plurality of proposed edits, each proposed edit comprising an addition, deletion or change of a map feature, each map feature located in a geographic area and associated with an at least one attribute;
receiving from a reviewer a selection of one of a first geographic area or a first attribute;
selecting a plurality of proposed edits responsive to the geographic area matching the first geographic area or the at least one attribute matching the first attribute;
placing the plurality of proposed edits in a queue associated with the reviewer;
receiving from the reviewer a request to share the queue with a second reviewer; and
associating the queue with the second reviewer.

2. The method of claim 1 further comprising:
determining a risk signal associated with each of the proposed edits in the queue;
determining a trust signal associated with the second reviewer;
comparing the trust signal of the second reviewer and the risk signal for one of the proposed edits and responsive to the risk signal of one of the proposed edits exceeding the trust signal of the second reviewer, removing the one of the proposed edits from the queue for the second reviewer.

3. The method of claim 1 wherein:
receiving from a reviewer a selection of one of a first geographic area or a first attribute comprises receiving a selection of a first geographic region and a first attribute; and
selecting a plurality of proposed edits responsive to the geographic area matching the first geographic area or the at least one attribute matching the first attribute comprises selecting a plurality of proposed edits responsive to the geographic area matching the first geographic area and the at least one attribute matching the first attribute.

4. The method of claim 1 wherein the queue comprises proposed edits proposed by a user who is a reviewer of proposed edits and further comprising:
determining a rank for the proposed edits proposed by a user who is a reviewer of proposed edits based on the number of edits reviewed by the user proposing the proposed edit.

5. The method of claim 4 wherein determining the rank for the proposed edits proposed by a user who is a reviewer of proposed edits based on the number of edits reviewed by the user proposing the proposed edit comprises determining the rank based on the ratio of the number of proposed edits proposed by the user to the number of proposed edits reviewed by the user.

6. The method of claim 4 wherein determining the rank for the plurality of proposed edits proposed by a user who is a reviewer of proposed edits is further based on a quality of the user's moderation.

7. The method of claim 6 wherein the quality of the user's moderation comprises a level of detail of the user's comments when moderating.

8. A system for moderating proposed edits to a map comprising:
a processor for executing computer program code; and
a non-transitory computer-readable storage medium storing executable program code for:
storing a plurality of proposed edits, each proposed edit comprising an addition, deletion or change of a map feature, each map feature located in a geographic area and associated with an at least one attribute;
receiving from a reviewer a selection of one of a first geographic area or a first attribute;
selecting a plurality of proposed edits responsive to the geographic area matching the first geographic area or the at least one attribute matching the first attribute;
placing the plurality of proposed edits in a queue associated with the reviewer;
receiving from the reviewer a request to share the queue with a second reviewer; and
associating the queue with the second reviewer.

9. The system of claim 8 further comprising program code for:
determining a risk signal associated with each of the proposed edits in the queue;
determining a trust signal associated with the second reviewer;
comparing the trust signal of the second reviewer and the risk signal for one of the proposed edits and responsive to the risk signal of one of the proposed edits exceeding the trust signal of the second reviewer, removing the one of the proposed edits from the queue for the second reviewer.

10. The system of claim 8 wherein:
receiving from a reviewer a selection of one of a first geographic area or a first attribute comprises receiving a selection of a first geographic region and a first attribute; and
selecting a plurality of proposed edits responsive to the geographic area matching the first geographic area or the at least one attribute matching the first attribute comprises selecting a plurality of proposed edits responsive to the geographic area matching the first geographic area and the at least one attribute matching the first attribute.

11. The system of claim 8 wherein the queue comprises proposed edits proposed by a user who is a reviewer of proposed edits and further comprising program code for:
determining a rank for the proposed edits proposed by a user who is a reviewer of proposed edits based on the number of edits reviewed by the user proposing the proposed edit.

12. The system of claim 11 wherein determining the rank for the proposed edits proposed by a user who is a reviewer of proposed edits based on the number of edits reviewed by the user proposing the proposed edit comprises determining the rank based on the ratio of the number of proposed edits proposed by the user to the number of proposed edits reviewed by the user.

13. The system of claim 11 wherein determining the rank for the plurality of proposed edits proposed by a user who is a reviewer of proposed edits is further based on a quality of the user's moderation.

14. The system of claim 13 wherein the quality of the user's moderation comprises a level of detail of the user's comments when moderating.

15. A non-transitory computer-readable storage medium storing executable program code for moderating proposed edits to a map the computer program code comprising program code for:
storing a plurality of proposed edits, each proposed edit comprising an addition, deletion or change of a map feature, each map feature located in a geographic area and associated with an at least one attribute;
receiving from a reviewer a selection of one of a first geographic area or a first attribute;
selecting a plurality of proposed edits responsive to the geographic area matching the first geographic area or the at least one attribute matching the first attribute;
placing the plurality of proposed edits in a queue associated with the reviewer;
receiving from the reviewer a request to share the queue with a second reviewer; and
associating the queue with the second reviewer.

16. The non-transitory computer-readable storage medium of claim 15 further comprising program code:
determining a risk signal associated with each of the proposed edits in the queue;
determining a trust signal associated with the second reviewer;
comparing the trust signal of the second reviewer and the risk signal for one of the proposed edits and responsive to the risk signal of one of the proposed edits exceeding the trust signal of the second reviewer, removing the one of the proposed edits from the queue for the second reviewer.

17. The non-transitory computer-readable storage medium of claim 15:
receiving from a reviewer a selection of one of a first geographic area or a first attribute comprises receiving a selection of a first geographic region and a first attribute; and
selecting a plurality of proposed edits responsive to the geographic area matching the first geographic area or the at least one attribute matching the first attribute comprises selecting a plurality of proposed edits responsive to the geographic area matching the first geographic area and the at least one attribute matching the first attribute.

18. The non-transitory computer-readable storage medium of claim 15 wherein the queue comprises proposed edits proposed by a user who is a reviewer of proposed edits and further comprising program code for:
determining a rank for the proposed edits proposed by a user who is a reviewer of proposed edits based on the number of edits reviewed by the user proposing the proposed edit.

19. The non-transitory computer-readable storage medium of claim 18 wherein determining the rank for the proposed edits proposed by a user who is a reviewer of proposed edits based on the number of edits reviewed by the user proposing the proposed edit comprises determining the rank based on the ratio of the number of proposed edits proposed by the user to the number of proposed edits reviewed by the user.

20. The non-transitory computer-readable storage medium of claim 18 wherein determining the rank for the plurality of proposed edits proposed by a user who is a reviewer of proposed edits is further based on a quality of the user's moderation.
